(19) United States
(12) Patent Application Publication
(10) Pub. No.: US 2026/0135898 A1
(43) Pub. Date: May 14, 2026

(54) MEDIA OBJECT VARIANT SELECTION AT PLAYBACK

(71) Applicant: VIASAT, INC., Carlsbad, CA (US)

(72) Inventors: Devin R. TOTH, Mechanicville, NY (US); Daniel M. NEWMAN, Littleton, MA (US)

(21) Appl. No.: 19/432,646

(22) Filed: Dec. 24, 2025

Related U.S. Application Data
(63) Continuation of application No. PCT/US2024/035809, filed on Jun. 27, 2024.
(60) Provisional application No. 63/510,842, filed on Jun. 28, 2023.
(60) Provisional application No. 63/585,201, filed on Sep. 25, 2023.

(51) Int. Cl. H04L 65/75; H04L 65/612; H04L 65/752

(52) U.S. Cl. CPC H04L 65/762; H04L 65/752; H04L 65/612

(57) ABSTRACT

Selection of a variant of a media object for delivery from a service provider to a user system using a delivery utility of available variants. The variants may each use different amounts of network resources. The delivery utility may be based on a network resource usage (e.g., a weighted network resource usage such as a provisioning cost value). The network resource usage may represent a cost to the service provider to transmit the variant. The delivery utility calculation may also be based on a predicted quality of experience for a variant. This may include a weighted probability of the quality of experience related to an effect of an adverse experience resulting from delivery of the variant (e.g., a churn cost value). The use of the delivery utility calculation may efficiently use communication network infrastructure to improve user quality of experience, server more users using given networking resources, or both.

### CROSS-REFERENCE TO RELATED APPLICATIONS

This application is a bypass continuation of Patent Cooperation Treaty Application No. PCT/US/035809, designating the U.S., filed on Jun. 27, 2024, entitled “MEIDA OBJECT VARIANT SELECTION AT PLAYBACK,” which claims priority to U.S. Provisional Ser. No. 63/510,842 filed on Jun. 28, 2023, entitled “MAKING TRANSMISSION, LOCAL STORAGE, AND EVICTION DECISIONS REGARDING MULTIMEDIA OBJECTS IN A MEDIA DELIVERY SYSTEM” and U.S. Provisional Ser. No. 63/585,201 filed on Sep. 25, 2023, entitled “MANAGING DELIVERY OF MEDIA CONTENT TO USERS ON A SHARED COMMUNICATIONS CHANNEL,” all of which are incorporated by reference herein in their entireties.

### BACKGROUND

Digital media objects may be delivered over a network to facilitate rendering a media object at a user device. For example, many users now obtain media objects for playback via network communications, such as through streaming services over the internet. With increased delivery of media objects over networks, the demand on network resources (e.g., hardware and software resources) has also increased. In this regard, it is advantageous to provide more efficient operation of networks to promote user experiences and to utilize network resources more effectively.

### SUMMARY

In some aspects, the techniques described herein relate to a method for serving a media object to a user in a communications system, including: receiving a request for the media object; identifying a plurality of variants available for the media object; calculating a delivery utility for each of the plurality of variants; selecting a selected variant from the plurality of variants based on the delivery utility of the selected variant relative to others of the plurality of variants; and serving the selected variant to the user to satisfy the request.

In some aspects, the techniques described herein relate to a system for serving a media object to a user in a communications system, including: a provider content module executed on a computing device at a service provider, the provider content module operative to: receive a request for a media object from a user terminal of the communication system, and identify a plurality of variants available for the media object; a delivery utility calculation module operative to calculate a delivery utility for each of the plurality of variants; and a forward link between the service provider and the user terminal for serving a selected variant from the plurality of variants based on the delivery utility of the selected variant relative to others of the plurality of variants.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Other implementations are also described and recited herein.

### BRIEF DESCRIPTION OF THE DRAWINGS

FIG. 1 illustrates an example system architecture in which a service provider is an integrated service of a communication provider.

FIG. 2 illustrates an example system architecture in which a service provider is a stand-alone service for delivery of media object selection with variant selection.

FIG. 3 illustrates an example of a media delivery system.

FIG. 4 illustrates an example of a media delivery system in which a shared communications channel comprises a satellite in communication with groups of user systems via spot beams.

FIG. 5 illustrates an example user terminal comprising a user media module.

FIG. 6 illustrates an example provider media module.

FIG. 7 illustrates a schematic example of a media object.

FIG. 8 illustrates an example of a manifest for a video media object.

FIG. 9 illustrates an example method for serving a media object to a user based on delivery utility.

FIG. 10 illustrates an example method for determining a providing cost value of a variant.

FIG. 11 illustrates an example method for determining a churn cost value of a variant.

FIG. 12 illustrates example computing devices capable of executing aspects of the present disclosure.

### DETAILED DESCRIPTION

While the disclosure is susceptible to various modifications and alternative forms, specific examples are shown by way of example in the drawings and are herein described in detail. It should be understood, however, that it is not intended to limit the disclosure to the particular form disclosed, but rather, the disclosure is to cover all modifications, equivalents, and alternatives falling within the scope as defined by the claims.

As noted above, the present disclosure generally relates to providing media objects over a communication network, such as to provide an improved streaming service for delivery of media objects over a network. In recent times, the amount of network resources dedicated to providing media objects to users has drastically increased. This, in turn, places ever-increasing demands on the network resources of communication providers, content providers, and other network stakeholders. In response, networks have been created and managed to attempt to provide efficiencies, thus making more effective use of network resources. For example, network improvements have been proposed for user-facing and server-side network architectures and approaches. Especially in times of high network utilization (e.g., peak usage periods), bandwidth and other resource strains on communication providers may result in degraded network performance. In turn, a quality of experience for users of the network may also suffer. As may be appreciated, this may result in increased costs, reduced revenues, or other negative effects for communication providers, service providers, content providers, or other network stakeholders.

The present disclosure generally facilitates improvements to network architectures, which may include a shared forward communication link (also referred to as a “shared forward link”). A shared forward communication link may provide connectivity to a plurality of user terminals on a client-side of the network, which may enable the multicasting of content to the plurality of user terminals on the client-side. The use of a shared forward communication link provides a unique opportunity to improve network performance. However, even in the context of a shared forward communication link, it may be advantageous to balance network utilization with a quality of experience for users. That is, while users may desire to receive high-quality media objects, network utilization associated with serving high-quality media objects may result in network degradation and user dissatisfaction.

As such, the present disclosure facilitates increased efficiencies in network utilization, thus improving network utilization, network performance, and/or user quality of experience. Specifically, the present disclosure may facilitate more efficient utilization of existing network resources such that the amount of bandwidth used for streaming media objects to users may be decreased, both in peak busy periods and off-peak periods. Additionally or alternatively, through more efficient use of networking resources, the quality of experience for users may be improved with existing networking resources. In turn, services provided using the approaches described herein may attract more users and provide monetary benefits to providers even without requiring costly infrastructure upgrades. Furthermore, in some examples described herein, consideration of user quality of experience may promote user retention and avoid user churn. “User churn” refers to a user discontinuing or deactivating services provided via the network or leaving the service provider. As may be appreciated, user churn may add cost to network operators and is preferably avoided.

The approaches provided herein facilitate a comprehensive approach to the selection of a media object variant to be provided to user terminals on a client-side of a communication network. In this regard, the approaches described herein may be provided as machine-executable instructions integrated with network nodes or hardware to allow the network to automatically make machine-executed decisions to improve the utilization of network hardware and software resources. In turn, the performance of network hardware and software is increased to facilitate improved performance of a network. Accordingly, the approaches described herein balance network utilization with user experience to improve network functionality. As such, existing network infrastructure may provide an improved level of service to more users and/or higher quality of experience can be provided to users of the network.

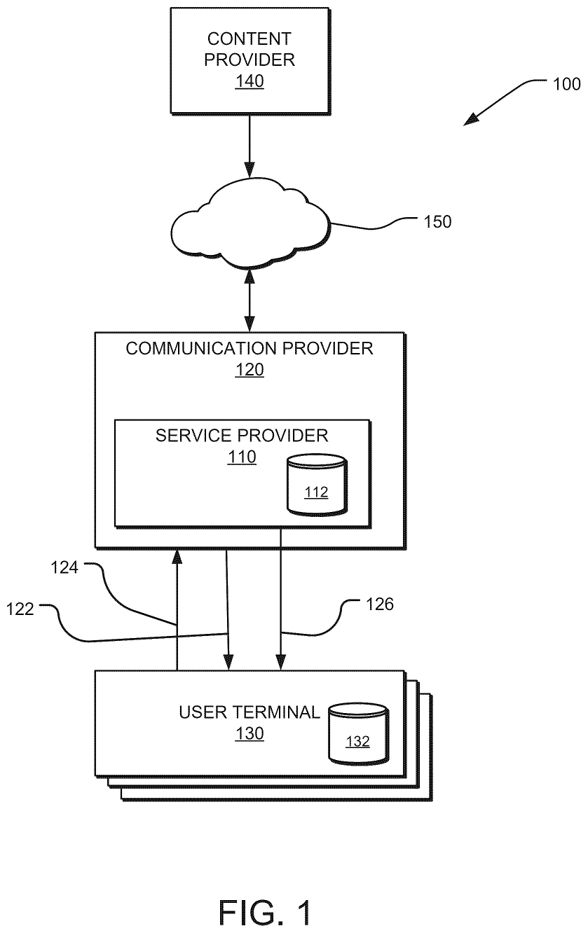

FIG. 1 illustrates an example of a network environment 100. The example network environment 100 shown in FIG. 1 may be referred to as a unitary system because a service provider 110 and a communication provider 120 comprise a common entity.

The network environment 100 may include one or more content providers 140. A content provider 140 may be a source of content. For example, the content provider 140 may be a content owner such as a studio or other content creator. In other examples, the content provider 140 may be a licensee, distributor of content, or content aggregator. In an example, a content provider 140 may be a streaming service that hosts a media catalogue of media objects.

The communication provider 120 provides data communication services to a plurality of user terminals 130. The communication provider 120 may alternatively be referred to as an Internet Service Provider (ISP). The communication provider 120 may provide communication services to a plurality of user terminals 130 using any one or more networking infrastructures. For example, the communication provider 120 may be a telecommunications provider that may provide data communications to user terminals 130 by way of a publicly switched telephone network (PSTN), digital subscriber line (DSL), television cable (CATV), integrated services digital network (ISDN), fiber optics, satellite communications, cellular communications, or other appropriate networking infrastructure. The communication provider 120 may provide data communication services that allow a user terminal 130 to access a wide area network, such as the Internet. As such, the network infrastructure of the communication provider 120 may facilitate unicast communication exchanges between a user terminal 130 and a destination over a wide area network 150, such as by way of packet-switched networking protocols such as the internet protocol suite (TCP/IP). In this regard, as shown in FIG. 1, the communication provider 120 may provide a forward link 122 and a return link 124 that allows for bidirectional communication of a user terminal 130 with a wide area network. The forward link 122 and return link 124 may include unicast communications that facilitate wide area network access (e.g., traditional internet access) to the user terminal 130.

In the unitary example shown in FIG. 1, the communication provider 120 may also include a service provider 110. A shared forward link 126 may be established between the service provider 110 and the user terminal 130. In the example shown in FIG. 1, the shared forward link 126 may be a separate communication link or may comprise a return link 124 as the service provider 110 may be integrated with the communication provider 120. That is, the service provider 110 may provide a multicasting capability to provide a requested media object to a plurality of user terminals 130 using the shared forward link 126. As noted above, by leveraging the potential efficiencies of a shared forward communication link, the service provider 110 may improve the utilization of networking hardware infrastructure. Specifically, in response to a request for a media object by a user terminal, the service provider 110 may calculate delivery utilities of a plurality of variants of the media object to determine which variant to server over the shared forward link 126 in response to the request.

The communication provider 120 may comprise an edge node of a broader network of the communication provider 120. In this regard, the communication provider 120 may include a provider content store 112 that may cache media objects at the edge node of the communication provider 120 to help efficiently communicate media objects to a user terminal 130.

In the unitary example of FIG. 1, the communication provider 120 may have the capability to provide multicast communication to a plurality of user terminals 130 using the shared forward link 126. As such, the multicasting capability of the communication provider 120 may be utilized by the service provider 110 to provide a variant of a requested media object to the plurality of user terminals 130. However, the communication provider 120 may also provide unicast communications with the user terminal 130 as described above. In this regard, in some network architectures (e.g., satellite communication networks), the forward link 122, return link 124, and shared forward link 126 may all be provided by the same networking infrastructure. That is, the network may include hardware that facilitates both the forward link 122 and shared forward link 126 using the same network components.

The user terminal 130 may comprise hardware, software, and firmware located at a user's premise. The user terminal 130 may include communication equipment to facilitate communication with the communication provider 120 and to receive a multicast from the service provider 110. In this regard, the user terminal 130 may include networking equipment that allows communication of unicast data between the user terminal 130 and the communication provider 120 as well as receipt of multicast communications from the service provider 110. In the context of the unitary system of FIG. 1, some communication links utilized by the communication provider 120 and the service provider 110 may be the same (e.g., in the case of a shared forward link provided by a common service provider 110/communication provider 120).

As described in greater detail below, the user terminal 130 may comprise a playback device that allows a user to view a media object delivered by the service provider 110. The user terminal 130 may facilitate a user to browse and request media content using hardware at the user terminal 130 (e.g., including a playback device that provides a user interface to a user). The user terminal 130 may include a user agent that executes an application such as a content provider application, an internet browser, or another application that allows a user to browse a media catalogue and request a media object for viewing. As may be appreciated, such browsing may be facilitated by unicast communication flows between the user terminal 130 and a remote entity via the forward link 122 and/or the return link 124. Furthermore, the user terminal 130 may include a user cache 132 comprising local storage resources in which media objects may be stored locally at the user terminal 130.

In the network environment 100, the user terminal 130 may communicate with the communication provider 120 and service provider 110 to facilitate delivery of a requested media object to the user terminal 130. For example, the user terminal 130 may communicate via unicast communications with the communication provider 120 to access and browse a media catalogue of the content provider 140. The media catalogue of the content provider 140 may comprise an internet resource that is accessed by the user terminal 130 using the network of the communication provider 120. Accordingly, the user terminal 130 may be able to access a plurality of content providers 140 such that the illustration of a single content provider 140 in FIG. 1 is intended to be illustrative and not limiting.

The user terminal 130 may present an interface to a user that allows a user to navigate the media catalogue of the content provider 140. Upon selection of a media object by the user terminal 130, the service provider 110 of the communication provider 120 may intercept the request for the media object. At this point, the service provider 110 may execute the functionality described herein to determine a variant of a requested media object to server to the user terminal 130 in a manner that enhances the efficiency of the network.

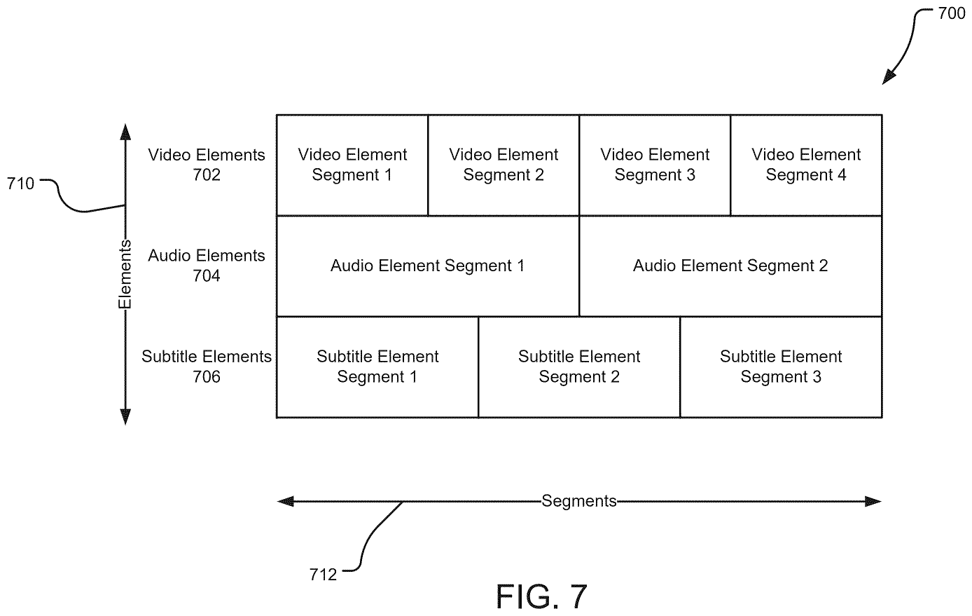

As used herein, a variant may refer to a specific instance of a media object. With further reference to FIG. 7, a schematic illustration providing details on the makeup of a media object is presented. Specifically, a media object 700 may comprise a plurality of media elements, each of which may have various renditions available. A media object may be part of a media catalogue provided by a content provider. A media object may comprise a movie, an episode of a television series, a song, a podcast, etc.

The media object 700 may comprise a plurality of concurrent media elements 710 that may collectively define the media object 700 to be rendered at the user system. While a media object 700 is referenced herein that denotes a plurality of media elements 710 that are concurrently rendered to provide the media content, the present disclosure is equally applicable to any media object, including those having a single media element, such as an audio file.

In an example, the media object 700 may include media elements 710 comprising a video element 702, an audio element 704, and a subtitle element 706. Additional or fewer media elements may be provided for various media objects. As noted above, in some examples, a media object may comprise a single media element (e.g., an audio element for an audio media object). The media elements 710 may comprise components or layers of the media object 700 that may be concurrently rendered to provide the media object 700 to a user for consumption. For example, the media object 700 may include a video element 702, which is accompanied by an audio element 704 comprising an audio track concurrent to the video element 702. While specific examples are described herein for illustration, media elements 710 of the media object 700 may include any appropriate media elements such as video elements, audio elements, subtitle elements, metadata elements, or other media elements.

In addition to the media elements 710, additional data comprising an extra element may be provided in connection with the media object 700. Such extras may include metadata or other information presented with the media object 700. In an example, an extra may be an advertisement or the like. In this regard, the extra comprising an advertisement may correspond in some way to the media object 700 or may correspond to the user system requesting the media object 700. For instance, the extra may comprise a targeted advertisement based on the media object 700 or the user system requesting the media object 700.

The media object 700 may be divided into segments 712, with a segment corresponding to a defined portion (e.g., a partial duration) of the media object 700. As shown in FIG. 7, each of the video element 702, the audio element 704, and the subtitle element 706 may comprise a plurality of segments 712 of a given duration of the media object 700. In this regard, the horizontal axis of FIG. 7 may be representative of time. A given duration (e.g., 60 seconds) of a media object 700 may be divided (or the media elements 710 comprising the media object 700 may be divided) into segments 712 (e.g., 1-second segments, 3-second segments, 5-second segments, etc.).

The segment lengths of each media element may be unique for at least some of the media elements 710. For example, in FIG. 7, the video element segments may be of a different duration than the audio element segments and may be of a different duration than the subtitle element segments. That is, segment durations need not be the same for each of the media elements 710 comprising a media object 700 such that, for example, a video element 702 may comprise a first segment duration (e.g., 1 second) whereas an audio element 704 may comprise a second segment duration (e.g., 3 seconds) that is different than the first segment duration. In other examples, the media element segments for different media elements 710 may be of the same duration (e.g., a video element segment and an audio element segment may be of the same duration). In any regard, media elements 710 of the media object 700 may be rendered together to present the media object. In addition, data for media element segments may be sequentially requested from a manifest for each of the media elements comprising the media object 700 to render the media object 700 at a user system (e.g., through HTTP messages or other TCP/IP protocols).

The delivery of the media elements 710 of a media object 700 may be coordinated using a manifest. A manifest may identify resources for use at a user system such that the user system may request and receive data for the media elements 710 to render the media object 700. In an example, a media player executed by hardware and/or software of the user system may be operative to read the manifest to request data identified in the manifest for rendering by the media player at the user system. A manifest may identify a plurality of renditions of one or more media elements that are available to be requested for the media object. Each rendition identified in the manifest may include one or more attributes that are readable by the client system. In addition, the manifest may include pointer information for each rendition that identifies resources for requesting the rendition of the media element of the media object. Accordingly, the manifest may identify the renditions having different attributes for the media elements that are available for request by a user system to render the media object, along with a pointer that can be used for requesting the rendition. A manifest can identify both media data and metadata. The manifest typically identifies different renditions of each media element that may have unique qualities or characteristics for the media element.

A manifest (e.g., received from a media content provider, content delivery network, or another source) may initially identify a large number of renditions for different ones of the media elements of the media object. Different renditions of the media elements may comprise different network usage characteristics or other qualities. Alternatively, the different renditions of the media elements may relate to other characteristics such as geolocation (e.g., to provide appropriate audio language renditions and/or subtitle language renditions for a given media object). Further still, the different renditions may relate to different capabilities of the user devices rendering the media object. For instance, renditions may be provided that comprise different codecs used to encode and decode media data of the media element. In this regard, the manifest may provide a user system with a “menu” of available renditions of media elements that may be requested. A variant of the media object may comprise a selection of renditions for each media element of the media object. As such, different variants of the media object may differ with respect to at least one rendition of the media object. As may be appreciated, different variants of a media content object may have different values for delivery and storage in a media delivery system.

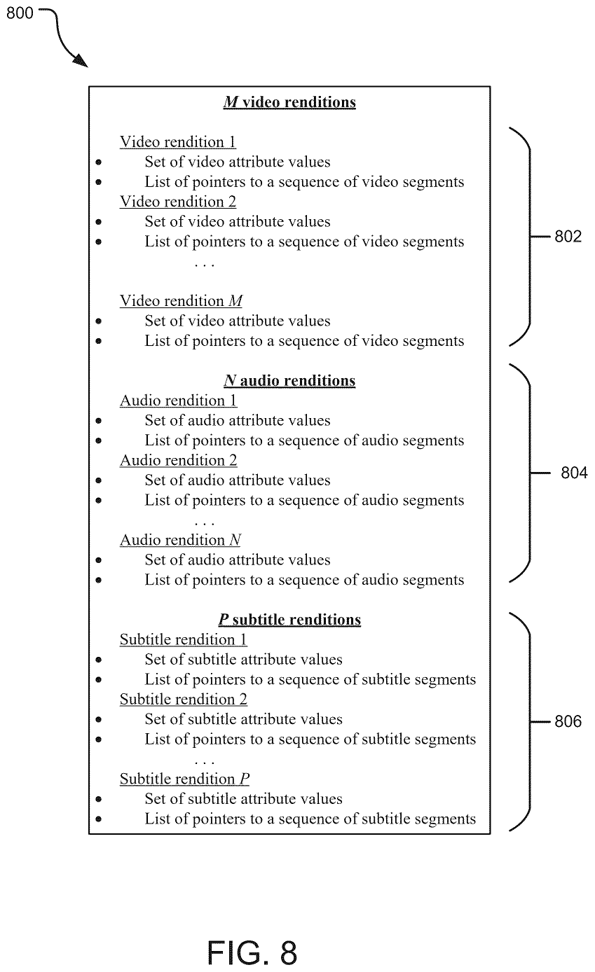

With additional reference to FIG. 8, an example of a manifest 800 is illustrated. The manifest 800 is an example for a video media object comprising three concurrent media elements: a video element 802, an audio element 804, and a subtitle element 806. As shown, the manifest 800 can identify multiple renditions for each media element. Each rendition may correspond to a unique version of the concurrent media element. As such, each rendition may include a set of one or more attributes that describe the rendition. The one or more attributes may be readable by a provider-media module or a user system. The attributes may define characteristics of the specific rendition of the media element. Each rendition of a media element also includes a list of pointers (e.g., universal resource locators (URLs), universal resource indicators (URIs), or the like) that may be utilized by a user system to request a sequence of segments of the rendition. In other examples, a manifest may be hierarchical with a top-level manifest including a listing of lower-level manifests. As an example, a top-level manifest may include a video manifest and an audio manifest. Each of the video manifest and the audio manifest may include renditions for video media elements and audio media elements, respectively. In turn, each lower-level manifests may include a listing of renditions that each include a list of pointers for use by a user system in requesting a sequence of segments of the renditions.

In the example illustrated in FIG. 8, the media object comprises M number of renditions of the video element 802, N number of renditions of the audio element 804, and P number of renditions of the subtitle element 806. In this regard, M, N, and P may each be independent variables of one or more renditions of each respective media element.

With regard to the video element, each video rendition is defined by a set of video attributes and comprises a list of pointers to sequential video segments that, when played, render that rendition of the video element of the media object. Examples of video attributes that can define a video rendition include an encryption format, a video encoding format (video codec), a quality level (e.g., a color model, a resolution, etc.), a dynamic range, and the like. Other examples of video attributes that define video renditions may include a %-seg value, maximum bit rate, average bit rate, a required bandwidth value (e.g., a network bandwidth measure required to deliver the rendition), a required latency value (e.g., a network latency measure required to deliver the rendition), and supported media player operating system(s). Here a %-seg value can correspond to the frequency at which the rendition has been consumed by a user. In some examples, the %-seg value of each rendition of a concurrent media element in a manifest can correspond to the frequency of user use relative to the other renditions of the concurrent media element. Thus, for example, the %-seg values of each video rendition in a manifest sum to 100%. As may be appreciated, different renditions may have different combinations of attributes, including combinations of any of the foregoing (e.g., a given resolution, encryption, a color model, and an average bit rate).

As also shown, each audio rendition is defined by a set of audio attributes and comprises a list of pointers to sequential audio segments that, when played, render that rendition of the audio element of the media object. Examples of audio attributes that can define an audio rendition include audio encoding format (audio codec), a number of audio channels, audio language, a required bandwidth value, a required latency value, and quality level. Other examples of audio attributes include a %-seg value (as described above), bit rate, and supported media player operating system(s).

Still referring to the example illustrated in FIG. 8, each subtitle rendition is defined by a set of subtitle attributes and comprises a list of pointers to sequential subtitle segments that, when played, render that rendition of the subtitle element of the media object. An example of an attribute that can define a rendition of the subtitle element includes language (e.g., English, Spanish, French, etc.).

As may be appreciated, different renditions may have different combinations of attributes, including combinations of any of the foregoing (e.g., a given resolution, an encryption, a color model, and an average bit rate). Some renditions of a given media element may share at least one attribute. For example, a first rendition and a second rendition may each have a video resolution attribute of 720 p. For example, the first rendition may have a high dynamic range and the second rendition may have a standard dynamic range.

A unique combination of renditions of the media elements of a media object may be referred to as a variant of the media object. In some examples, the approaches described herein may be used to determine a delivery utility of a plurality of variants that include different renditions of multiple different media elements such that the evaluated variants may include different renditions in a plurality of formats of the media object. In still other examples, the plurality of variants for which a delivery utility is calculated may only vary with respect to one rendition parameter. For example, a plurality of different bitrates may be provided for a given format of a media object. That is, the variants of the format of the media object may be the same except for a single variable, such as variants with different bitrates.

The delivery utility for a variant may represent the value to the service provider of delivering the variant in response to a request from a user. The delivery utility for a variant may be based on a network resource usage for delivery of the variant. In some examples, the network resource usage may relate to technical aspects of delivery of the variant. For example, this may include a required bandwidth, or other measured value required, for delivery of the variant. In some examples, the network resource usage may comprise a weighted network resource usage. The weighted network resource usage may include weighting or other factoring of network resource usage for use in determining delivery utility. As an example, the weighted network resource usage may be based on a time period in which the variant is to be delivered, such that delivery in different time periods may have different effects on the weighted network resource usage. The weighted network resource usage may include a provisioning cost value as described in greater detail below.

The delivery utility for a variant may also be at least in part based on a predicted quality of experience the variant is expected to provide the user. The predicted quality of experience may be determined empirically, based on parametric conditions provided for a variant (e.g., a threshold bit rate or bandwidth for a variant), using predictive models, or by other means. The predicted quality of experience may also comprise a weighted probability of a quality of experience. The weighted probability of a quality of experience may provide weighting or other factoring of the effect of the predicted quality of experience. The weighted probability of a quality of experience may quantify an effect of delivery of a variant. For example, the weighted probability of a quality of experience may quantify an adverse effect the delivery of the variant may have. This may provide a counter to the network resource usage. That is, if network resource usage alone is used to determine a delivery utility, quality of experience for users may suffer as conservation of network resources may be solely considered. However, by factoring the effect of an adverse experience of the user, a delivery utility based on network resource usage and a predicted quality of experience may balance the interests of conservation of network resources and user satisfaction. One example of a weighted probability of a quality of experience may be a churn cost value as described in greater detail below.

In any regard, when a user requests a media object, a determination may be made as to what variant of the media object will be delivered to the user terminal 130 for rendering the media object at the user terminal 130. Specifically, the service provider 110, upon intercepting the request for the media object by the user terminal 130, may perform processing to determine which variant to serve to the user terminal 130 based on the delivery utilities for the available variants of the content requested. This processing may provide the efficiencies attendant to the use of the shared forward communication link.

Upon the service provider 110 determining the delivery utility of the available variants of the requested media object, a selected variant may be selected based on the delivery utility for the selected variant. The selected variant may be served to the user terminal 130. This selection of the selected variant may be based on the delivery utility of the selected variant in relation to the delivery utilities of the other variants that are available. For example, the selected variant may have the greatest delivery utility among the available variants for which delivery utilities are determined. In any regard, the selected variant may be delivered to a user terminal to satisfy a request for the content. In some examples, the selected variant, or a portion thereof, may be resident in a cache at the user terminal such that delivery of the selected variant is accomplished locally at the user terminal by delivery from the cache. In other examples, the selected variant may be communicated from the provider-side of a network to the client-side. The selected variant may be communicated to the client-side using a forward link of the communication system. In one example, the selected variant may be multicast by the communication provider 120 using the shared forward communication link such that the user terminal 130 (and possibly other user terminals 130 on the shared forward communication link) may receive the media object for playback at the user terminal 130. Further details regarding the determination of delivery utility are provided below.

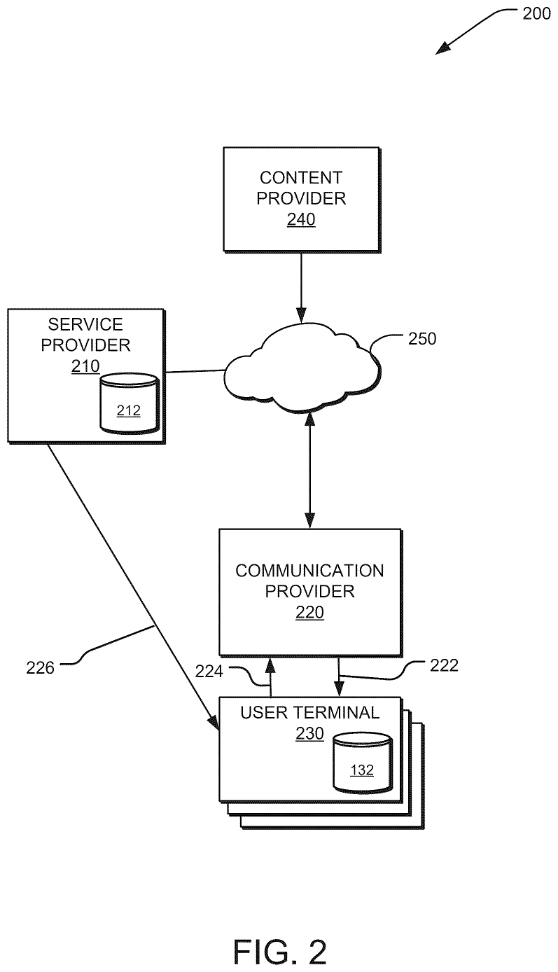

In contrast to the example of a unitary system of the network environment 100 in FIG. 1, FIG. 2 illustrates a network environment 200 in which a stand-alone service provider 210 may provide a media object to a user terminal 230. Like in the network environment 100, the network environment 200 may include one or more content providers 240 that host media catalogues from which a user of a user terminal 230 may request a media object. The details of the communication provider 120 described above are equally applicable to the communication provider 220 of FIG. 2. That is, the communication provider 220 may be any communication provider that provides a user terminal 230 access to a wide area network 250 using a forward link 222 and a return link 224. The forward link 222 and return link 224 may be provided by the network infrastructure of the communication provider 220 to facilitate general internet access at the user terminal 230.

However, unlike in the network environment 100, the communication provider 220 and the service provider 210 may not be a common entity. Rather, the stand-alone service provider 210 may be a separate entity from the communication provider 220. For example, the stand-alone service provider 210 and the communication provider 220 may be distinct entities that are not co-located but may be in operative communication via a wide area network 250. In this regard, the stand-alone service provider 210 may be in operative communication with the wide area network 250 as well as providing a shared forward link 226 to the user terminal 230 in the network environment 200. As may be appreciated, the shared forward link 226 may be provided to the user terminal 230 using a different networking infrastructure than the forward link 222 and return link 224 provided by the communication provider 220. For example, the stand-alone service provider 210 may operate independent networking infrastructure to provide the shared forward link 226. The stand-alone service provider 210 may include a provider content store 212 comprising edge node storage of variants of media objects.

The user terminal 230 may generally be as described above for the user terminal 130. However, the user terminal 130 may include networking equipment for communications with the communication provider 220 while including at least reception equipment for receipt of a multicast communication by the stand-alone service provider 210 over the shared forward link 226.

Accordingly, a service flow in the network environment 200 may differ from the network environment 100. Initially, like in the network environment 100, the user terminal 230 may utilize unicast communications over the forward link 222 and return link 224 of the networking infrastructure of the communication provider 220 to access and browse a media catalogue of the content provider 240. Moreover, a user of the user terminal 130 may initiate a request for a media object from the media catalogue of the content provider 240.

In the network environment 200 of FIG. 2, the request for the media object by the user terminal 230 may be redirected to the communication provider 220 for processing the request according to the disclosure presented herein. That is, a content provider 240 may redirect the user terminal 230 to the stand-alone service provider 210 such that the stand-alone service provider 210 receives the request via the wide area network 250.

In this regard, the stand-alone service provider 210, having received the redirected request for the media object, may determine a delivery utility for available variants of the media object. Upon determination of the variant with the greatest delivery utility, that variant may be served to the user terminal 230 via the shared forward link 226. As noted above, this may result in other user terminals 230 on the shared forward link 226 also receiving the variant.

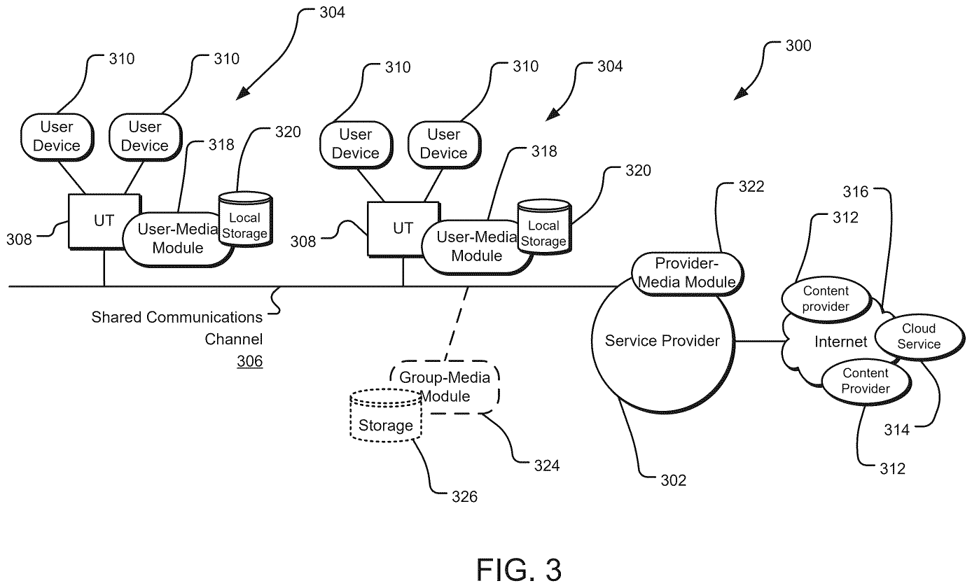

Turning to FIG. 3, an example of a media delivery system 300 is shown in which the approaches described herein may be utilized. A service provider 302 (e.g., which may be unitary with a communication provider as described in FIG. 1 or a stand-alone service provider as described in FIG. 2) provides connectivity to one or more user systems 304 on a shared forward communication link comprising a shared communications channel 306. While specific implementations of the shared communications channel 306 are illustrated below, the shared communications channel 306 may comprise a shared forward link of a cable television network, a satellite communication network, a cellular network, or any other appropriate network infrastructure. The service provider 302 may be operative to multicast content to the user system 304 using the shared communications channel 306.

Each user system 304 can comprise a user terminal 308 (UT) capable of receiving data from the service provider 302 via the shared communications channel 306. The service provider 302 can provide media objects to user devices 310 from one or more content providers 312 (e.g., via a content delivery network of the content providers 312), one or more cloud services 314, or other sources of media objects via the Internet 316 or another wide area communications network. Examples of user devices 310 at a user terminal 308 include but are not limited to, a smartphone, a connected television set, a laptop or desktop computer, tablet computers, a set-top box, or any other user premise equipment device capable of rendering media objects. Each user system 304 may also include a user-media module 318 and local storage 320 (e.g., comprising a local cache) capable of caching media objects or renditions of media elements of a media object. The user-media module 318 may receive a redirected or intercepted request in response to a user requesting a media object. In turn, the user-media module 318 may coordinate with a provider-media module 322 to complete a request for a media object at the user terminal 308. The user-media module 318 may manage cached media objects from the local storage 320, including coordinating an index (e.g., a dictionary) for the local storage 320 with the provider-media module 322. Additionally, the user-media module 318 may communicate data regarding media consumption, playback device parameters, or other parameters regarding the user system 304.

The user-media module 318 may comprise appropriate hardware, software, and/or firmware to execute this functionality. For example, the user-media module 318 may comprise an application-specific integrated circuit (ASIC), a field programmable gate array (FPGA), a hardware processor in operative communication with a memory, or other devices. In the case of a processor and memory, the memory may store machine-readable instructions that configure the processor to perform the functionality described for the user-media module 318.

In some examples, there may be a group-media module 324 connected to the shared communications channel 306, which may include user-group storage 326 (e.g., comprising a cache) for a group of one or more of the user systems 304 connected to the service provider 302 via the shared communications channel 306. The group-media module 324 may coordinate a request for a media object for delivery to a plurality of user systems 304 (e.g., including user systems of a given multicast domain of the shared communications channel 306). In addition, the group-media module 324 may provide functionality discussed above for the user-media module 318 relative to a plurality of user terminals 308 of the shared communications channel 306.

The group-media module 324 may comprise appropriate hardware, software, and/or firmware to execute this functionality. For example, the group-media module 324 may comprise an application-specific integrated circuit (ASIC), a field programmable gate array (FPGA), a hardware processor in operative communication with a memory, or other devices. In the case of a processor and memory, the memory may store machine-readable instructions that configure the processor to perform the functionality described for the group-media module 324.

As shown, the provider-media module 322 may be located at a provider-side of the shared communications channel 306 (e.g., at or near the service provider 302). The provider-media module 322 may be operated by a communication service provider or by a stand-alone service provider as described above in relation to FIGS. 1 and 2, respectively. The provider-media module 322 may be executed at a server of the service provider. The provider-media module 322 may be operative to determine delivery utility for one or more variants of a media object as described in greater detail below to determine a variant of the media object to serve to the user terminal 308 of the shared communications channel 306. Furthermore, the provider-media module 322 may coordinate multicasting of a variant of a media object in response to a request. In addition, the provider-media module 322 may maintain storage indexes that correspond to the local storage 320 of the user terminals 308. Additionally, the provider-media module 322 may coordinate storage and request for media objects from upstream CDNs.

The provider-media module 322 may comprise appropriate hardware, software, and/or firmware to execute this functionality. For example, the provider-media module 322 may comprise an application-specific integrated circuit (ASIC), a field programmable gate array (FPGA), a hardware processor in operative communication with a memory, or other devices. In the case of a processor and memory, the memory may store machine-readable instructions that configure the processor to perform the functionality described for the provider-media module 322.

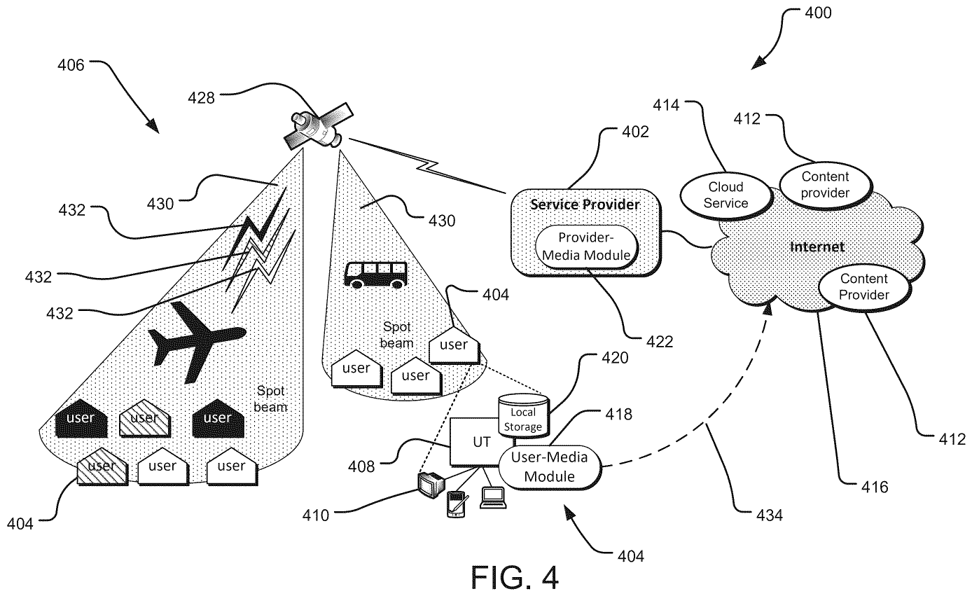

FIG. 4 illustrates a specific example of a media delivery system 400 in which a shared communications channel 406 comprises a satellite 428 in communication with groups of user systems 404 via spot beams 430. In this regard, user systems 404 in a given spot beam 430 may be included in a shared communication channel. Furthermore, in some examples, a spot beam 430 may have multiple carriers 432. For example, the multiple carriers 432 may each have a different frequency for transmission of data on a respective carrier. In FIG. 4, the multiple carriers 432 are represented with different shadings. The shadings of the user systems 404 reflect the respective one of the multiple carriers 432 to which a user system 404 belongs. Accordingly, a shared communication channel or shared communication link may comprise a given carrier 432 within a spot beam such that user systems 404 tuned to the given carrier 432 in a spot beam 430 may belong to the shared communication channel.

In any regard, FIG. 4 may be a specific implementation of the media delivery system 300 shown in FIG. 3 in which the shared communications channel 306 may include the satellite 428, spot beams 430, and/or carriers 432 to deliver content to the user systems 404. As shown, each user system 404 can include a user terminal 408 comprising a satellite terminal (not shown) and one or more user devices 410, which can be any of the user devices mentioned above. Each user system 404 can also include a user-media module 418 and local storage 420 (e.g., comprising a local cache) capable of caching media objects. The user-media module 418 may also provide similar functionality to the user-media module 318 noted above. In examples of a unitary system, the satellite 428, spot beams 430, and/or carriers 432 may provide networking infrastructure to support both the unicast communications of a forward link and return link as well as a shared forward link.

The media delivery system 400 may also include a provider-media module 422 at a service provider 402 that has similar functionality described above. Also, while not shown, a group-media module and/or group cache like that discussed above may be provided in connection with one or more of the spot beams 430 or carriers 432 to provide similar functionality as that described above for the group-media module 324 and user-group storage 326 relative to the shared communications channel 306.

The media delivery system 400 may also include one or more media content providers 412 and/or one or more cloud services 414. The one or more media content providers 412 and/or one or more cloud services 414 may provide media objects to the service provider 402 via a wide area network, such as the internet 416, or another type of communications network.

As noted above, a user system 404 may utilize the spot beams 430 and carrier 432 of the satellite 428 for unicast communications to provide access to the internet 416. In turn, once a media object is requested, the media object may be delivered to the user system 404 via the spot beams 430 and carrier 432 of the satellite 428. As such, the media delivery system 400 of FIG. 4 may facilitate a unitary system structure as shown in FIG. 1.

Alternatively, a user system 404 may utilize a communication provider link 434 for communication of data via the Internet 416. In this regard, upon selection of a media object, the request may be redirected to the service provider 402 for delivery of the media object to the user system 404 using the spot beams 430 and a carrier 432 of the satellite 428 for delivery of the media object. As such, the communication provider link 434 may facilitate a stand-alone service provider architecture as described in FIG. 2.

Further still, FIG. 4 illustrates a number of mobile terminals served by the spot beams 430 and carriers 432 of the satellite 428. As such, the media delivery system 400 of FIG. 4 may provide communication services to mobile terminals as user systems 404. As may be appreciated, the mobile terminals may move between spot beams 430 and/or carriers 432 of the satellite 428. As such, some parameters (e.g., related to provisioning costs, churn costs, or other parameters described below) may be different for different spot beams 430 or carriers 432. As such, when a mobile terminal moves to a new carrier 432 or spot beams 430, some aspects related to determining delivery utility for media objects requested by the mobile terminal may be changed in view of the new spot beams 430 and/or carrier 432.

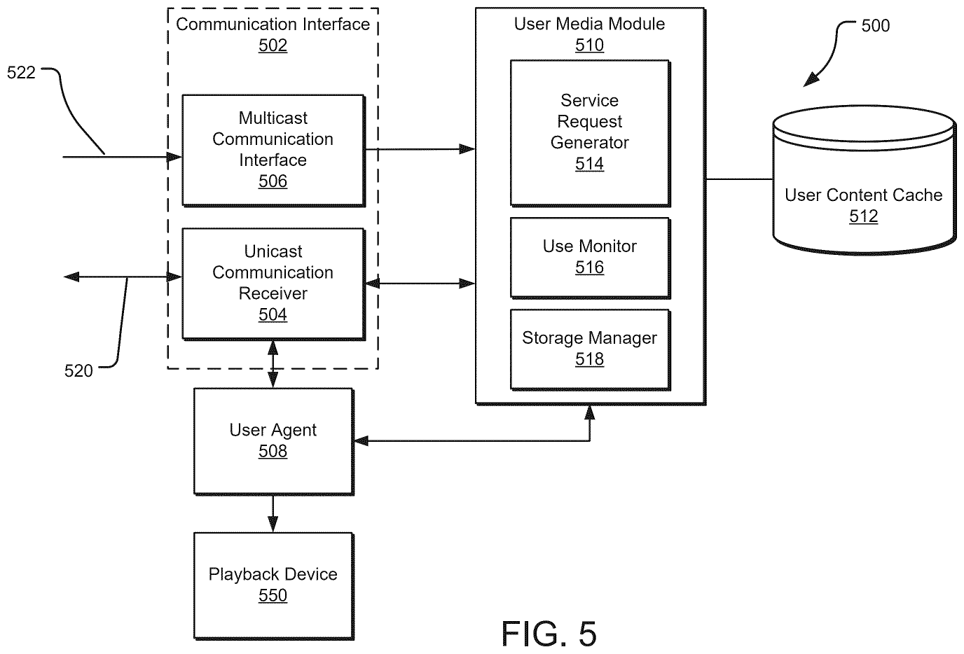

FIG. 5 illustrates a more detailed example of a user terminal 500 that may be utilized in the present disclosure. The user terminal 500 may include a communication interface 502 that facilitates communication with one or more networks to exchange and/or receive data via respective ones of the one or more networks. In this regard, the communication interface 502 may include hardware, software, and firmware that facilitates the exchange of data with one or more networks with which the user terminal 500 is in communication. Specifically, the communication interface 502 may provide bidirectional unicast capability using a unicast communication interface 504 and multicast receipt capability using a multicast communication interface 506.

The unicast communication interface 504 may facilitate bidirectional communication 520 with a wide area network. In one example, the unicast communication interface 504 may receive data via a return link of a communication provider that also provides a shared forward link 522. In this regard, the return link of the bidirectional communication 520 and the shared forward link 522 may be provided via a common network. Alternatively, the unicast communication interface 504 may receive data via a return link that is provided by a separate networking infrastructure from the shared forward link 522. The unicast communication interface 504 may include any hardware, software, and firmware that facilitates the bidirectional communication 520. For instance, the unicast communication interface 504 may include a network interface controller, a wireless network interface controller, a modem, or other components.

The communication interface 502 may also include a multicast communication interface 506. The multicast communication interface 506 may be operative to at least receive a multicast communication via a shared forward link 522 provided by a service provider. The multicast communication interface 506 may include appropriate hardware, software, and firmware to facilitate receipt of the multicast communication. For example, the multicast communication interface 506 may include a receiver, a modem, a network interface controller, or other hardware to facilitate receipt of the multicast communication. As noted above, the shared forward link 522 may be provided over any network infrastructure capable of multicasting data such as, for example, a satellite spot beam, a cellular multicast group, or the like.

The user terminal 500 may also comprise a user agent 508. The user agent 508 may comprise a computing device or module of a computing device that executes functionality for media object selection. For example, the user agent 508 may execute a stand-alone application that provides access to media objects for selection by a given content owner. Alternatively or additionally, the user agent 508 may execute third-party applications (e.g., of content providers or content owners) to allow a user to browse respective media catalogs available via the third-party applications. Further still, the user agent 508 may execute a web browser that allows a user to browse one or more media catalogues for media object selection. The user agent 508 may be a discrete computing device at the user terminal 500 or may be integrated into a playback device 550.

In any regard, the user agent 508 may execute to allow for user browsing of a media catalogue for selection of a media object. This may involve bidirectional communications via the unicast communication interface 504. The unicast communication interface 504 may utilize request and response protocols such as hypertext transfer protocol (HTTP) to facilitate browsing of the media catalogue. Upon selection of a media object by the user terminal 500, the request from the user agent 508 may be intercepted or redirected to a service provider as noted above.

The user terminal 500 may also include a playback device 550. The playback device 550 may render a media for playback to the user. The playback device 550 may include a user interface including a display screen and audio output that allows a media object to be rendered for consumption by a user. The playback device 550 may comprise peripheral components such as a connected television, projector, audio receiver, or other multimedia component for rendering media to a user. The playback device 550 may be characterized by playback device parameters such as a screen size, a screen resolution, a screen dynamic range, an audio output capability, an audio channel count, playback device hardware parameters, or other information that may affect the ability of the playback device 550 to render a media object.

As noted above, the media playback device 550 may be integrated with the user agent 508 such that the playback device may be a computing device that executes the user agent 508 as well as providing playback functionality for presenting a media content object to a user. Alternatively, as noted above, the playback device 550 may be a peripheral device connected to a device executing the user agent 508. In one example, the user agent 508 may execute on customer premise equipment provided by a communication provider or service provider.

The user terminal 500 may also comprise a user media module 510. As noted above, a user media module 510 may be provided at each user terminal of a shared forward link in a communication system. Moreover, while a user media module 510 is described herein, a group media module may also provide the functionality of the user media module 510 to a plurality of user terminals of a shared forward link. The user media module 510 may be in communication with the communication interface 502 such that the user media module 510 may receive information from a multicast communication interface 506 and may utilize bidirectional communication with the unicast communication interface 504.

The user media module 510 may include a service request generator 514. Upon selection of a media object for playback at the user agent 508, a redirected or intercepted request may be routed to the user media module 510. In response, the service request generator 514 may initiate a request to a provider media module of the service provider to request a selected media object. In this regard, instantiation of the process described herein may commence when the request for the media object is directed to the user media module 510 to initiate delivery of the media object from the service provider. In an example, upon selection of a media object by the user, the user agent 508 may communicate with the user media module 510. For example, the user agent 508 may redirect a communication to the service request generator 514 or the service request generator 514 may intercept a request for a media object. Alternatively, a communication from a service provider may be received and directed to the service request generator 514. The service request generator 514 may initiate the process of interfacing with a provider media module of a service provider for serving a variant of the selected media content object using the approach described herein.

In an example, the service request generator 514 may issue a request for the media object to the provider media module of the service provider. The request may include information regarding the playback device 550 to assist the provider media module in making a determination of which variant of the media object to serve to the user terminal 500. In some examples, the service request generator 514 may receive a manifest from the provider media module. The provider media module may manipulate a manifest associated with the requested media object as described in greater detail below. The received manifest may identify the selected variant of the media object having the greatest delivery utility.

In addition, the service request generator 514, upon receipt of an indication of a selected variant of the media object, may determine whether a selected variant is stored in the user content cache 512. If the selected variant is in the user content cache 512, the user media module 510 may retrieve the media object variant from the user content cache 512 for local delivery of the media object to the playback device 550. Alternatively, if the service request generator 514 determines that the selected variant is not stored in the user content cache 512, the service request generator 514 may initiate a request to the provider media module for the selected variant as a communication over the shared forward link 522 (e.g., as a unicast or multicast communication). This may cause the provider media module to multicast the selected variant as described in greater detail below.

The user media module 510 may further include a storage manager 518. The storage manager 518 may provide indexing of the user content cache 512 to allow for efficient and rapid referencing of data contained in the user content cache 512. In this regard, the storage manager 518 may provide dictionary coding of the user content cache 512 or other efficient indexing strategies to allow for rapid searching of the user content cache 512 by the user media module 510. In this regard, the storage manager 518 may also share an index such as a dictionary of the user content cache 512 with the provider media module such that the provider media module may also have access to an index of content stored in the user content cache 512.

The user media module 510 may also include a use monitor 516. The use monitor 516 may be operative to monitor media object consumption or other user activity at the user terminal 500. As media objects are requested, cached, or consumed at the user terminal 500, the use monitor 516 may generate information regarding such usage. The use monitor 516 may also monitor quality of experience parameters that may be used to generate historical quality of experience performance for the user terminal 500. As described in greater detail below, the historical quality of experience performance generated by the use monitor 516 may be utilized in determining delivery utility.

As referenced above, the user terminal 500 may include a user content cache 512. The user content cache 512 may comprise storage accessible to the user terminal 500. As such, the user content cache 512 may include local computer storage such as a hard disk drive, a solid-state drive, a network-attached storage appliance, or other appropriate local storage hardware located at the user terminal 500.

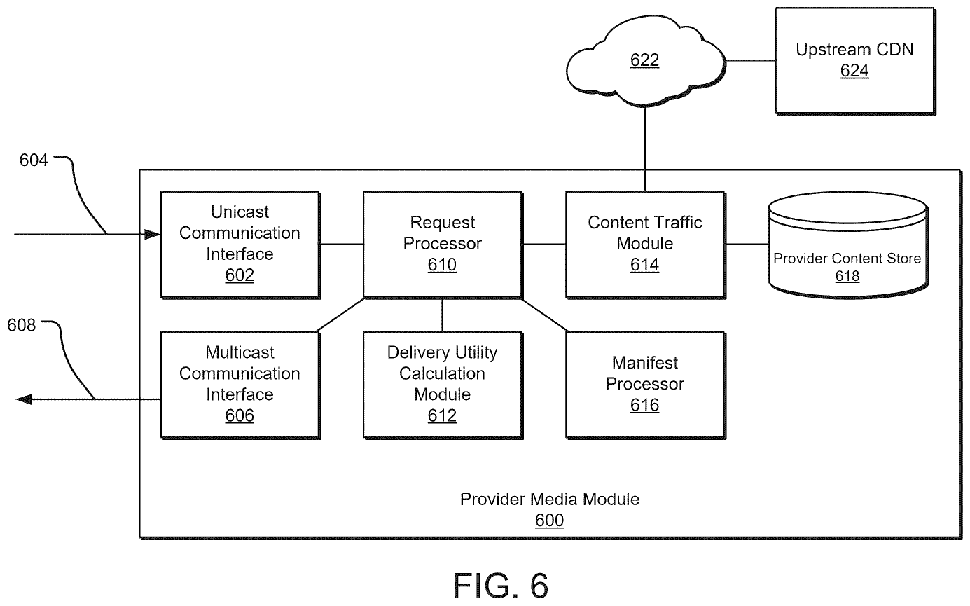

FIG. 6 illustrates an example of a provider media module 600. FIG. 6 includes a more detailed example of a provider media module as described above in relation to FIG. 3 or 4. In any regard, the provider media module 600 may be located at a service provider or may be executed as a cloud computing instance under the control of the service provider. The provider media module 600 may facilitate functions associated with the serving of a media object, including determination of delivery utility of variants of a media object.

The provider media module 600 may include a unicast communication interface 602. In a unitary system in which the communication provider includes the service provider, the unicast communication interface 602 may comprise a return link 604 that may be provided by the same network as a shared forward link 608. Alternatively or additionally (e.g., in the context of a standalone system), the unicast communication interface 602 of the provider media module 600 may include a network interface to a wide area network for receipt of data via a different network as what facilitates the shared forward link 608. In any regard, the unicast communication interface 602 may be operative to receive a request for a media object of a user terminal.

The provider media module 600 may include a multicast communication interface 606. The multicast communication interface 606 may be operative to communicate a media object over a shared forward link 608 to one or more user terminals. As described above, the shared forward link 608 may comprise any communication modality in which multicast communications are provided to user terminals on the client side of the network environment. In this regard, the multicast communication interface 606 may support a satellite network in which the shared forward link 608 may be a satellite spot beam or carrier. In other examples, the shared forward link 608 may be a cellular multicast network or other network modality capable of multicasting data to a plurality of user terminals on the client side of the network environment.

The provider media module 600 may include a request processor 610. The request processor 610 may be in operative communication with the unicast communication interface 602 such that a request for the media content object received at the unicast communication interface 602 over the return link 604 may be provided to the request processor 610. The request processor 610 may be in operative communication with a content traffic module 614. The request processor 610 may poll the content traffic module 614 to determine available variants of the media object. That is, the content traffic module 614 may have access to a provider content store 618 and/or other content distribution networks 624 (e.g., via a wide area network 622) to obtain identifications of the available variants for the requested media object. Specifically, a manifest of the media object may be provided that may include a plurality of renditions for media elements of the media object. From this information, the content traffic module 614 may determine one or more variants having different renditions for at least one media element. For example, the one or more variants may differ with respect to a bit rate of the media object.

The content traffic module 614 may be in operative communication with the manifest processor 616. The manifest processor 616 may be operative to trim a manifest to remove one or more renditions for a media element for a media object. The manifest processor 616 may perform trimming in multiple stages for a given media object. For example, the manifest processor 616 may perform initial trimming of a manifest to limit the available variants for a media object prior to calculation of delivery utility for one or more variants. This may include initial trimming based on, for example, capabilities of the playback device of a user terminal making a request. That is, specific formats of a media content object may be removed from the manifest by the manifest processor 616 prior to determining delivery utility for variants as some variants in given formats may be inappropriate for delivery to the user terminal based on the playback device capabilities. For example, manifest trimming may be provided according to Patent Cooperation Treaty Application No. PCT/US 2023/022280 filed on May 15, 2023, entitled “MEDIA OBJECT DELIVERY OVER A SHARED COMMUINCATIONS CHANNEL WITH MANIFEST TRIMMING,” the entirety of which is incorporated by reference herein. As such, the manifest processor 616 may provide a trimmed version of an original manifest to the request processor 610 for determination of delivery utility of a reduced number of variants as compared to the original manifest. As noted above, in one example, a format of a media object is selected and all variants not belonging to the format may be removed. The remaining variants may correspond to the media object in the format having different respective bitrates.

Furthermore, the manifest processor 616 may provide further trimming of a manifest to limit a manifest to a selected variant that is selected using a delivery utility calculation. That is, the manifest processor 616 may further trim a manifest such that a manifest delivered to a user terminal may only include the selected variant based on the delivery utility calculation performed by the delivery utility calculation module 612.

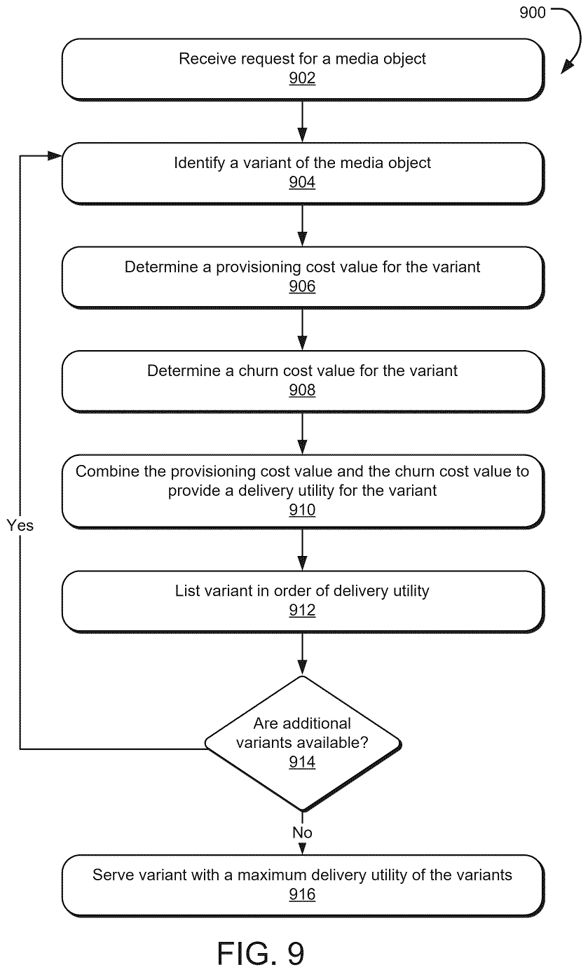

The request processor 610 may also interface with a delivery utility calculation module 612. The delivery utility calculation module 612 may calculate a delivery utility for each of a plurality of variants of the requested media object. Once the delivery utility for each available variant of the media object has been calculated by the delivery utility calculation module 612, the request processor 610 may determine which of the variants to serve to a user terminal based on the respective delivery utilities of the available variants. As noted above, the request processor 610 may interface with a manifest processor 616 that may eliminate non-selected variants from a manifest to be provided to a user media module in response to a request from the user media module. The deliver utility calculation module 612 may calculate delivery utility for one or more variants of a requested media object based on the processes described below in relation to FIGS. 9-11.

If the selected variant to be provided to the user terminal is not stored in a user content cache 512 of the user terminal, the request processor 610 may receive a request from the user content module for the selected variant of the media object to be served from the provider media module. The request processor 610 may further interface with the content traffic module 614 to determine whether the selected variant is available in the provider content store 618. If the selected variant is available in the provider content store 618 at the provider media module 600, the request processor 610 may retrieve the selected variant from the provider content store 618 and provide the selected variant to the multicast communication interface 606 for communication of the selected variant over the shared communications link 608. If the selected variant is not included in the provider content store 618, the content traffic module 614 may make a further request to the content distribution network 624 or another source of the media object to retrieve the selected variant to be provided to the multicast communication interface 606.

FIG. 9 depicts an example of a method 900 for serving a variant of a media content object based on calculated delivery utilities of a plurality of variants of the media content object. As described below, the method 900 may include determining a weighted network resource usage as a provisioning cost value. However, in other examples, the weighted network resource usage may be determined in an alternative manner such as by measuring communication system resources to be utilized in delivery of the variant. In addition, the method 900 may include determining a weighted probability of a quality of experience as a churn cost value. Here also other approaches to determining a weighted probability of a quality of experience may be utilized such as predicting positive or negative qualities of experience for a user or determination and quantification of other adverse events.

The method 900 may include a receiving operation 902 in which a request for a media object is received at a provider media module. The provider media module may be provided as either a standalone service provider or an integrated service provider according to either of the systems described in FIGS. 1 and 2. The request for the media object received in the receiving operation 902 may be received from the unicast communication interface at the provider media module as described above.

The method 900 may also include an identifying operation 904 in which a variant of a requested media object is identified (e.g., from a manifest of a plurality of variants for the media object). In this regard, a given one of the variants may be identified such that a delivery utility of the variant may be determined.

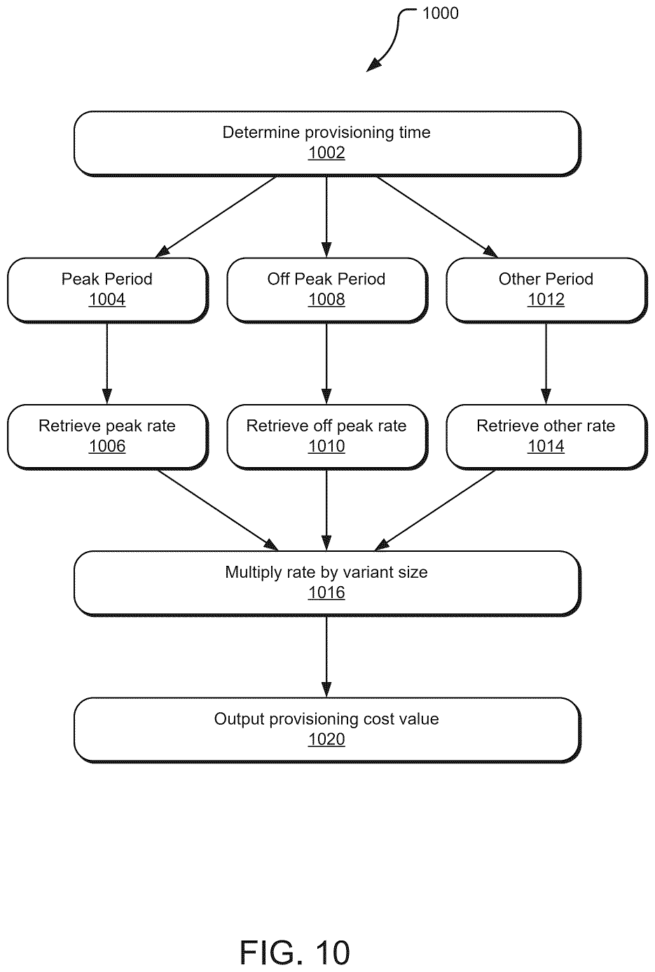

Specifically, determining the deliver utility may include a determining operation 906 in which a provisioning cost value for the variant is determined. Generally, the provisioning cost value represents a cost to the service provider to provide the specific variant to a user terminal on the client side of the network. Details regarding determining the provisioning cost value for a variant performed in the determining operation 906 is described in greater detail below with respect to FIG. 10.

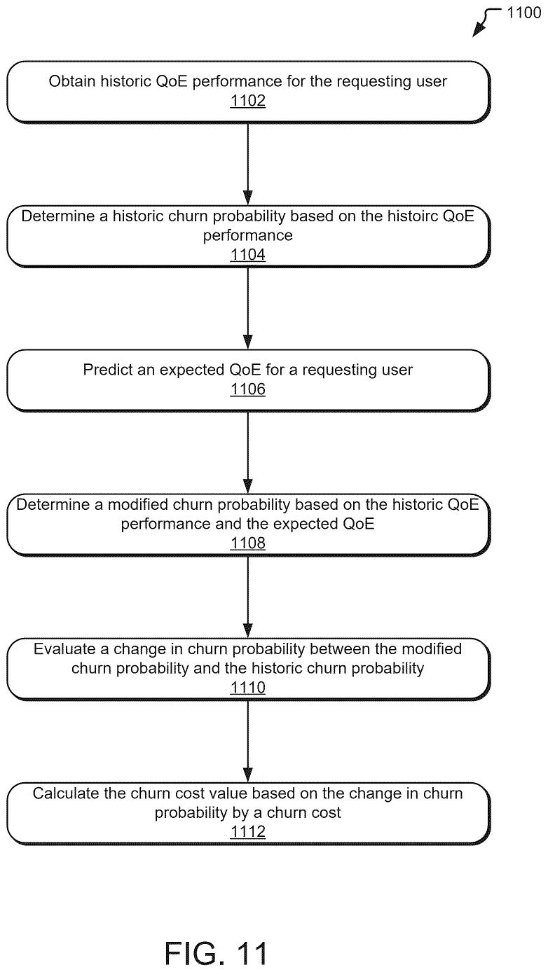

In addition, determining the deliver utility for the variant may include a determining operation 908 in which a churn cost value for the variant is determined. The churn cost value represents a value associated with the change in probability of user churn in the event of delivery of the variant being considered. As may be appreciated, there may be costs associated with user churn, in which a user discontinues service, such as retrieval of equipment, loss of revenue, overhead associated with account management, or other costs. Additional details regarding determining the churn cost value performed in the determining operating 908 for a variant is described in greater detail below with respect to FIG. 11.

The method 900 may include a combining operation 910 in which the provisioning cost value determined in the determining operation 906 and the churn cost value determined in the determining operation 908 may be combined to provide a delivery utility for the variant. A listing operation 912 may be performed in which the variant under consideration may be listed relative to the deliver utility of other variants having been considered in the method 900.

As such, the method 900 may include a logic block 914 that determines if there are additional variants available for the media object that has been requested. If additional variants are available, the method 900 may iterate to the identifying operation 904 in which another of the available variants is identified and the process for determining the deliver utility may be repeated. In turn, the additional variant may be added to the list of variants in the listing operation 912.

If the logical block 914 determines that no additional variants are available, the method 900 may proceed to a serving operation 916 in which a selected variant having a maximum delivery utility of all variants in the list of variants generated in the listing operation(s) 912 may be selected to be served to a user terminal. As may be appreciated, a serving operation 916 may include communicating the selected variant to a multicast communication interface for multicasting over a shared forward link of the communication system. In other examples, upon selection of the selected variant, a trimmed manifest including the selected variant may be served to the user terminal. The user terminal may determine if the selected variant is stored in the user content cache. If so, the variant may be retrieved locally. If not, the variant may be requested from the provider content module and the variant may be multicast using a shared forward link.

While the method 900 depicted in FIG. 9 provides one example for determining delivery utility, it may be appreciated that additional or fewer factors may be considered when determining delivery utility. That is, other factors in addition to a provisioning cost value and a churn cost value may be added to the determination of a delivery utility. For example, a multicast value associated with a value provided to other, non-requesting user terminals on a shared forward link may be considered when determining the delivery utility of a variant. In this regard, rather than determining the deliver utility specific to a requesting user terminal, some additional consideration may be provided to the overall value to all or a portion of the user terminals that may receive the requested variant via the shared forward communication link. As such, the example provided in FIG. 9 is not intended to be limiting as other considerations or values associated with the delivery utility may be determined and utilized in the selection of a given variant to be served.

As noted above, in the determining operation 906, a provisioning cost value is determined for a variant. FIG. 10 depicts additional details regarding the determination of a provisioning cost value. Specifically, it is recognized that the provisioning cost value may differ based upon a time of day in which the media object is to be served to the user or other factors such as network status at the time of request. That is, it is recognized that network resources may be valued differently based on factors including the congestion or likely congestion of the network. In this regard, certain times of day may exhibit greater network congestion and utilization than others. Such periods are often referred to as peak busy periods or peak periods. As such, other times of the day outside of a peak period may be referred to as off-peak time periods. Further still, other distinct periods may be identified in which the value for network utilization may differ from either peak or off-peak time periods. In this regard, specific rates for network utilization during different respective periods may be provided. The rates for the different periods may be empirically derived or may be utilized as tuning parameters that are selectively adjusted to elicit a desired behavior of the system.

Because the provisioning cost value may be time-dependent, a method 1000 for determining the provisioning cost value may include a determining operation 1002 in which the time at which the media object will be provided to the user terminal is determined. Accordingly, the method 1000 may proceed based on the time of the request or based on other factors (e.g., network parameters) that exist at the time of the request. As shown, a peak period 1004, an off-peak period 1008, and another period 1012 may be provided. In this regard, the peak period 1004 and/or off-peak period 1008 may be defined relative to specific times of day. Furthermore, the other period 1012 may be associated with certain conditions that may be based on time of day, network utilization, or other network conditions (e.g., current network conditions) that may trigger the other period 1012.

Depending upon the determined period, different rates for a cost associated with provisioning may be retrieved. Specifically, if the peak period 1004 is determined, a peak rate 1006 may be retrieved. If an off-peak period 1008 is determined, an off-peak rate may be retrieved 1010. Additionally, if the other period 1012 is determined, an other rate 1014 may be retrieved. The rates may be provided as a cost per gigabyte figure. As such, the peak rate 1006 may be generally greater than the off-peak rate 1010, understanding that network resources may be more scarce or valuable during the peak period 1004. As such, increasing the rate for a given period may result in the system being more conservative regarding bandwidth usage. In addition, while three periods are depicted in the method 1000 of FIG. 10, it may be appreciated that any number of periods having any relative conditions may be provided with specific rates that may be provided for each period.

The method 1000 may further include a multiplying operation 1016 in which the retrieved rate may be multiplied by a size of the variant to be delivered via the shared forward link to determine the provisioning cost value for the variant. As may be appreciated, the larger the amount of data required to be transmitted for a variant (e.g., the network bandwidth required to provide the variant to the requesting user), the larger provisioning cost value for the variant. As such, variants that are fully or partially stored at the user content cache may require no additional data or an amount of data that is less than the total size of the variant of the media object to be transferred using the shared forward link. In this regard, fully or partially cached variants of a media object may be preferred over variants that require network utilization to transmit because cached variants may have a reduced provisioning cost.

The method 1000 may include an outputting operation 1020 in which the provision cost value determined by the multiplication performed in the multiply operation 1016 is output. In this regard, the provision cost value may be returned in the determining operation 906 of FIG. 9 to be utilized in determining the deliver utility for the variant. As may be appreciated, because the process depicted in FIG. 9 may be iterative for each available variant, the method 1000 shown in FIG. 10 may be repeated for each given variant to be considered.

FIG. 11 depicts a method 1100 for determining a churn cost value, which may be performed in the determining operation 908 of FIG. 9. As generally described above, the churn cost value may represent a value associated with a change in probability of user churn in view of providing a variant. Specifically, the churn cost value may be related to the probability of providing a quality of experience to a user based on the variant under consideration, the probability of churn in view of the quality of experience expected for the delivery of the variant, and a value of churn for the given network. Each of these concepts is described in greater detail regarding the steps of the method 1100 below.

The churn cost value may be determined in view of a change in the probability of churn for delivering a variant under consideration. As the churn cost value represents a change in probability, historical quality of experience performance may be retrieved for a requesting user to determine a historic churn probability. As may be appreciated in the following discussion, the churn cost value may be generally based on a total number of media object requests for a given user. That is, a churn probability for users having fewer requests in a churn period may more greatly impact the churn cost value in the event of a bad quality of experience. In contrast, a churn probability for users that have many requests in a turn period may not be as greatly affected by a single bad quality of experience for requested media object.

In any regard, the method 1100 may include an obtaining operation 1102 in which historical quality of experience performance for a requesting user is retrieved. The obtaining operation 1102 may include obtaining actual historical performance for a quality of experience at the requesting user (e.g., from a use monitor 516 as described above).

The quality of experience performance may be based on quality of experience performance indicators. Specifically, the manner in which prior served media objects performed at a user terminal relative to the quality of experience performance indicators may dictate the historic quality of experience performance. The historic quality of experience performance for the requesting user may be determined within a churn period. The churn period may comprise a window of time over which the quality of experience performance of prior deliveries affects the probability of user churn. That is, the churn period may be tied to a length of time that a given quality of experience affects a user's likelihood to churn. As such, the churn period may be tied to a billing cycle (e.g., typically a 30-day period) or may be empirically derived based on a determination of the length of time the quality of experience for a media object delivery affects a user's churn probability.

The method 1100 may further include a determining operation 1104 in which a historic churn probability for the requesting user is determined based on the historical quality of experience performance. The historic churn probability may be algorithmically derived using an algorithm taking as an input the historic quality of experience performance for the user terminal. In other examples, the historic churn probability may be determined based on a predictive model trained using actual user behavior data relative to quality of experience performance. In this regard, training data comprising information on user churn instances paired with corresponding historic quality of experience performance data associated with the user churn instances may be used to train a machine learning model. In turn, historic quality of experience performance data from the obtaining operation 1102 may be input into the machine learning model to determine the historic churn probability in the determining operation 1104.

Further still, whether determined by an algorithmic approach or a machine learning model approach, the historic churn probability for a given user terminal may also consider non-quality of experience related factors such as user demographics, receipt of free content, or other factors that may be determined to affect user churn probability outside of quality of experience related factors. Such non-quality of experience related factors may include the probability of relocation of users outside of a service area or other non-performance related factors that may contribute to churn. Further still, historic churn probability may be determined at a discrete time, such as a time of a request for a media object or may be performed continuously over a given stream of a media object such that the churn probability is determined in real time in view of actual performance of network delivery of the media object to a user terminal during a stream of the media object.

The method 1100 may further include a predicting operation 1106. The predicting operation 1106 may be used to predict an expected quality of experience for a requesting user being served a variant under consideration. The quality of experience may be characterized relative to one or more quality of experience categories. In one example, the quality of experience categories may be binary with a good category and a bad category defining the possible quality of experience outcomes. In other approaches, other quality of experience categories may be provided to characterize possible quality of experience outcomes such as a low quality of experience, a medium quality of experience, and a high quality experience. Further still, the expected quality of experience may be provided as a continuous value over a given range such as from 0 to 1 or from 0 to 100.

Regardless of the number of quality of experience categories provided, the respective quality of experience categories may be defined relative to quality of experience performance indicators. That is, the expected quality of experience for a requesting user being served a variant under consideration may be determined based on how the variant is expected to perform relative to the one or more quality of experience performance indicators. Examples of quality of experience performance indicators include, but are not limited to, whether a media object start failure occurs, whether a media object playback failure occurs, whether a user exits before playback start after a threshold start time, whether a media object begins playback within a threshold playback time, a minimum fidelity based on a user screen associated with the request.

In addition, the quality of experience performance indicators may be combined in different ways to determine an expected quality of experience. For example, certain quality of experience performance indicators may be more heavily weighted than others when determining the expected quality of experience for a variant. The manner in which the quality of experience performance indicators are combined to provide an expected quality of experience for a requesting user may be based on modeled behavior, which may be provided as a machine learning model trained from a store of historic performance data. In other examples, the manner in which quality of experience performance indicators are combined to provide an expected quality of experience may be based on externally derived information such as user survey data or the like.

Furthermore, a quality of experience performance indicator may relate to characteristics of a given media object requested. Such characteristic of the media object may be provided as metadata of the requested media object. For example, a quality experience performance indicator may be based on the genre of the requested media object. In one example, an action movie may benefit from a higher quality of video than if the media object requested is a cartoon. As such, the quality of experience performance indicators may vary based on metadata for the media object such as the genre of the media object.

In any regard, the expected quality of experience for a given variant may be determined in view of the quality of experience performance indicators. As noted above, the expected quality of experience may be determined using a machine learning model. Such a machine learning model may be trained using stored user data regarding previously served variants, network characteristics, actual delivery quality, or other information. That is, the model may provide an expected performance of a variant relative to the quality of experience performance indicators by applying the model to a given variant in a given context to determine the expected quality of experience for the variant.

In other examples, the expected quality experience for the variant may be based on objective measures such as a minimum fidelity per screen size value. This objective measure may be determined based on information regarding a playback device of the requesting user. Furthermore, an expected quality of experience may be at least in part based on whether the variant is to be served from the provider side of the network (e.g., from the provider media module) or if the variant is available in the user content cache at the client side. As may be appreciated, an expected quality of experience may be more likely categorized as a good quality of experience if the variant is available in the user content cache because variables regarding network performance for delivery of the variant may not affect the provision of the variant to the user.

Furthermore, a model for providing an expected quality experience for a variant may also factor an amount of a given rendition of a variant contained in the client content cache. For example, expected quality experience for a variant that is entirely stored in the client content cache may be different than for a variant for which only a portion (e.g., 25%, 50%, 75%) of the variant is stored in the client content cache. That is, the model may that a portion of the variant may be required to be delivered over the shared forward communication link, which may be subject to hard to predict variables that affect the expected quality of experience for the variant.

The method 1100 may further include a determining operation 1108 in which a modified churn probability is determined. The modified churn probability may be based on the historical quality of experience performance and the expected quality experience determined in the method 1100. That is, the modified churn probability may be determined using the same algorithmic approach or machine learning model described above used to determine the historic term probability. That is, the modified churn probability may represent a change in churn probability considering an expected quality of experience for a variant in combination with the historical churn probability.

In one example, the expected quality of experience may be a probability distribution of a variant achieving each of the quality of experience categories. Using the example of a binary (e.g., good/bad) quality of experience category structure, an expected quality of experience may include a probability distribution of the variant achieving a good quality experience and a bad quality of experience. As such, the probability distribution may represent the respective probabilities of the variant achieving each of the quality of experience categories. As such, the modified churn probability determined in the determining operation 1108 may represent a change in the probability of the user churning based on the expected quality of experience provided by the variant being considered. In this regard, the change in churn probability may be a weighted combination over the probability distribution of each quality of experience category. That is, the more likely the variant achieves a given quality of experience category, the more heavily that quality of experience category probability may influence the change in churn probability. The method 1100 may include an evaluating operation 1110 in which the change in churn probability between the modified churn probability (e.g., as determined based on historic quality of experience performance data and the probability distribution of achieving an expected quality of experience) is determined.

The method 1100 may further include calculating the churn cost value in a calculating operation 1112, which may be based on the change in churn probability between the modified churn probability and the historical churn probability and a churn cost. A churn cost may be empirically derived based on cost measures associated with user churn. In other examples, the churn cost may be a tunable parameter that is selectable for the system to elicit specific system behavior. In any regard, in one example the churn cost value may be determined by combining (e.g., multiplying) the churn cost with the change in churn probability. This achieves a churn cost value representative of the effect on churn cost associated with serving the variant under consideration. In one example, the calculating operation 1112 may provide a safeguard for a minimum quality to be delivered to the requesting user. This may prevent the system for determining that it is best not to serve the user any variant of the media object in response to the request.

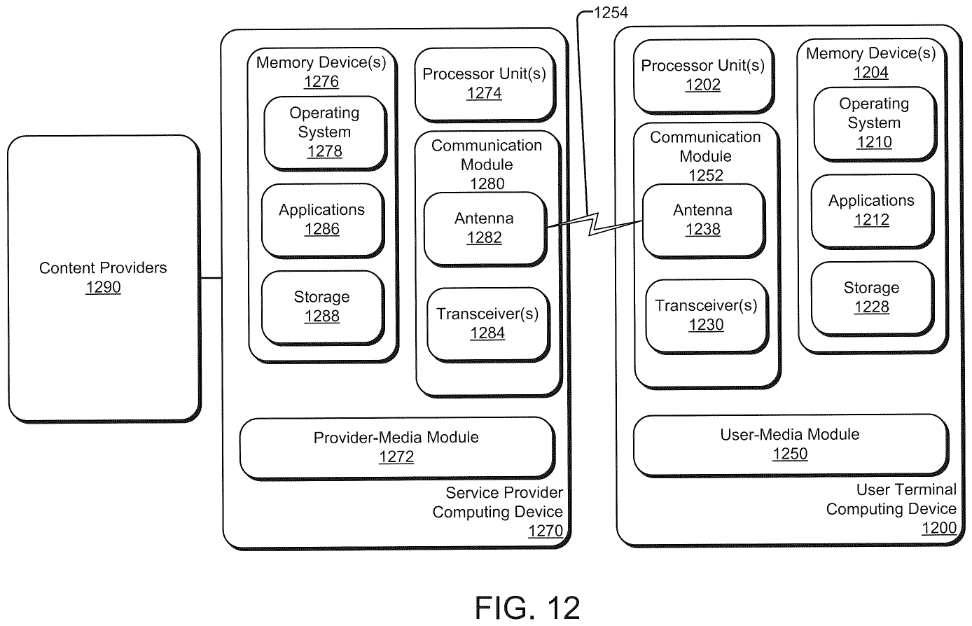

FIG. 12 illustrates an example schematic of a user terminal computing device 1200 suitable for implementing aspects of the disclosed technology. The user terminal computing device 1200 generally executes a user-media module 1250 in connection with the foregoing description. The user terminal computing device 1200 includes one or more processor unit(s) 1202 and memory 1204. The memory 1204 generally includes both volatile memory (e.g., RAM) and non-volatile memory (e.g., flash memory). An operating system 1210, such as the Microsoft Windows® operating system, the Apple macOS operating system, the Linux operating system, or the like resides in the memory 1204 and is executed by the processor unit(s) 1202. The memory 1204 may also include machine readable instructions that are executable by the one or more processor unit(s) 1202 to execute functionality of the user-media module 1250.

The user terminal computing device 1200 may also include a communication module 1252. The communication module 1252 may include any appropriate hardware, software, and firmware to enable communication via respective communication channels 1254 with a service provider computing device 1270. For example, the communication module 1252 may include a router (not shown), modem (not shown), transceiver 1230, antenna 1238 or other equipment to facilitate communication by the communication module 1252.

One or more applications 1212 may be loaded in the memory 1204 and executed on the operating system 1210 by the processor unit(s) 1202 to provide functionality of the user-media module 1250 in a manner described above. Applications 1212 may receive input from various input local devices such as a keypad, mouse, stylus, touchpad, joystick, an instrument-mounted input, or the like. The user terminal computing device 1200 may also include various other components, such as a positioning system (e.g., a global positioning satellite transceiver) and storage devices 1228. Other configurations may also be employed.

In an example implementation, the user terminal computing device 1200 comprises hardware and/or software embodied by instructions stored in the memory 1204 and/or the storage devices 1228 and processed by the processor unit(s) 1202. The memory 1204 may be the memory of a host device or of an accessory that couples to the host. Additionally or alternatively, the user terminal computing device 1200 may comprise one or more field programmable gate arrays (FPGAs), application-specific integrated circuits (ASIC), or other hardware/software/firmware capable of providing the functionality described herein.

As noted above, the user terminal computing device 1200 may be in communication with a service provider computing device 1270 via the shared communication channel 1254. The service provider computing device generally executes a provider-media module 1272 in connection with the foregoing description. The service provider computing device 1270 includes one or more processor unit(s) 1274 and memory 1276. The memory 1276 generally includes both volatile memory (e.g., RAM) and non-volatile memory (e.g., flash memory). An operating system 1278, such as the Microsoft Windows® operating system, the Apple macOS operating system, the Linux operating system, or the like resides in the memory 1276 and is executed by the processor unit(s) 1274.

The service provider computing device 1270 may also include a communication module 1280. The communication module 1280 may include any appropriate hardware, software, and firmware to enable communication via the shared forward communication link 1254 with the user terminal computing device 1200. For example, the communication module 1252 may include a router (not shown), modem (not shown), transceiver 1284, antenna 1282 or other equipment to facilitate communication by the communication module 1280.

One or more applications 1286 may be loaded in the memory 1276 and executed on the operating system 1278 by the processor unit(s) 1274 to provide functionality of the provider-media module 1272 in a manner described above. Applications 1286 may receive input from various input local devices such as a keypad, mouse, stylus, touchpad, joystick, an instrument-mounted input, or the like. The service provider computing device 1270 may also include various other components, such as a positioning system (e.g., a global positioning satellite transceiver) and storage devices 1288. Other configurations may also be employed.

In an example implementation, the service provider computing device 1270 comprises hardware and/or software embodied by instructions stored in the memory 1276 and/or the storage devices 1288 and processed by the processor unit(s) 1274. The memory 1276 may be the memory of a host device or of an accessory that couples to the host. Additionally or alternatively, the service provider computing device 1270 may comprise one or more field programmable gate arrays (FPGAs), application-specific integrated circuits (ASIC), or other hardware/software/firmware capable of providing the functionality described herein. In other examples, the service provider computing device 1270 and/or the provider-media module 1272 may be executed as a cloud computing instance such that the service provider computing device 1270 may comprise virtualized resources provided via cloud computing architecture.

The service provider computing device 1270 may be in further communication with one or more content providers 1290. The service provider computing device 1270 may access the one or more content providers 1290 via a network or local connection to access content data and/or receive a manifest according to the foregoing disclosure.

The user terminal computing device 1200 and/or service provider computing device 1270 may include a variety of tangible processor-readable storage media and intangible processor-readable communication signals. Tangible processor-readable storage can be embodied by any available media that can be accessed by the user terminal computing device 1200 and service provider computing device 1270 and includes both volatile and non-volatile storage media, removable and non-removable storage media. Tangible processor-readable storage media excludes intangible communications signals and includes volatile, non-volatile, removable, and non-removable storage media implemented in any method or technology for storage of information such as processor-readable instructions, data structures, program modules, or other data. Tangible processor-readable storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other tangible medium which can be used to store the desired information and which can be accessed by the user terminal computing device 1200. In contrast to tangible processor-readable storage media, intangible processor-readable communication signals may embody processor-readable instructions, data structures, program modules, or other data resident in a modulated data signal, such as a carrier wave or other signal transport mechanism. The term “modulated data signal” means an intangible communications signal that has one or more of its characteristics set or changed in such a manner as to encode information in the signal. By way of example, and not limitation, intangible communication signals include signals traveling through wired media such as a wired network or direct-wired connection, and wireless media such as acoustic, RF, infrared, and other wireless media.

Some implementations may comprise an article of manufacture. An article of manufacture may comprise a tangible storage medium to store logic. Examples of a storage medium may include one or more types of processor-readable storage media capable of storing electronic data, including volatile memory or non-volatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, operation segments, methods, procedures, software interfaces, application program interfaces (API), instruction sets, computing code, computer code, code segments, computer code segments, words, values, symbols, or any combination thereof. In one implementation, for example, an article of manufacture may store executable computer program instructions that, when executed by a computer, cause the computer to perform methods and/or operations in accordance with the described implementations. The executable computer program instructions may include any suitable type of code, such as source code, compiled code, interpreted code, executable code, static code, dynamic code, and the like. The executable computer program instructions may be implemented according to a predefined computer language, manner, or syntax, for instructing a computer to perform a certain operation segment. The instructions may be implemented using any suitable high-level, low-level, object-oriented, visual, compiled, and/or interpreted programming language.

In some aspects, the techniques described herein relate to a method for serving a media object to a user in a communications system, including: receiving a request for the media object; identifying a plurality of variants available for the media object; calculating a delivery utility for each of the plurality of variants; selecting a selected variant from the plurality of variants based on the delivery utility of the selected variant relative to others of the plurality of variants; and serving the selected variant to the user to satisfy the request.

In some aspects, the techniques described herein relate to a method, wherein the delivery utility for a variant is calculated at least based on one or more of: a network resource usage for delivery of the variant, and a predicted quality of experience the variant is expected to provide the user.

In some aspects, the techniques described herein relate to a method, wherein the delivery utility of the variant is based on the network resource usage and the predicted quality of experience.

In some aspects, the techniques described herein relate to a method, further including: determining a weighted network resource usage for the variant, the weighted network resource usage representing the network resource usage of a service provider for delivery of the variant to the user.

In some aspects, the techniques described herein relate to a method, wherein the weighted network resource usage includes a provisioning cost value.

In some aspects, the techniques described herein relate to a method, wherein the provisioning cost value is dependent is based upon a time of the request relative to a plurality of time periods.

In some aspects, the techniques described herein relate to a method, wherein the plurality of time periods at least includes a peak period and an off-peak period.

In some aspects, the techniques described herein relate to a method, wherein a provisioning cost rate for the peak period is greater than for the off-peak period.

In some aspects, the techniques described herein relate to a method, wherein the provisioning cost value is dependent on a size of the variant to be transmitted using a shared forward link.

In some aspects, the techniques described herein relate to a method, further including: determining a weighted probability of a quality of experience corresponding to the predicted quality of experience the variant is expected to provide the user.

In some aspects, the techniques described herein relate to a method, wherein the weighted probability of the quality of experience quantifies an effect of an adverse experience resulting from delivery of the variant.

In some aspects, the techniques described herein relate to a method, wherein the weighted probability of the quality of experience includes a churn cost value representative of an effect of the predicted quality of experience on the user.

In some aspects, the techniques described herein relate to a method, wherein the churn cost value is based on a predicted change in a probability the user discontinues service with a service provider within a churn period in response to serving the variant to a requesting user.

In some aspects, the techniques described herein relate to a method, wherein the churn cost value is based on the predicted quality of experience for a requesting user having received the variant.

In some aspects, the techniques described herein relate to a method, wherein the predicted quality of experience includes a probability distribution of a quality of experience for serving the variant being categorized into each of a plurality of quality of experience categories.

In some aspects, the techniques described herein relate to a method, wherein each of the plurality of quality of experience categories is defined by one or more quality of experience performance indicators.

In some aspects, the techniques described herein relate to a method, wherein the one or more quality of experience performance indicators include one or more of: whether a media object start failure occurs, whether a media object playback failure occurs, whether a user exits before playback start after a threshold start time, whether a media object begins playback within a threshold playback time, or a minimum fidelity based on a user screen associated with the request.

In some aspects, the techniques described herein relate to a method, further including: determining the probability distribution of the variant being categorized into each of the plurality of quality of experience categories based on a quality of experience probability model.

In some aspects, the techniques described herein relate to a method, wherein the quality of experience probability model is at least partially based on a source of the media object being one of a server side of the communications system or a local cache in local storage of the requesting user.

In some aspects, the techniques described herein relate to a method, wherein the quality of experience probability model is at least partially based on one or more of a bitrate of the variant, a screen size associated with the request, a genre of the media object, and current network conditions.

In some aspects, the techniques described herein relate to a method, further including: evaluating a change in churn probability by calculating a difference between a historic churn probability based on historic quality of experience performance over a churn period and a modified churn probability based on the historic quality of experience performance and the probability distribution of the quality of experience probability of the variant over the plurality of quality of experience categories.

In some aspects, the techniques described herein relate to a method, wherein the change in churn probability includes a weighted calculation of the change in churn probability for each of the plurality of quality of experience categories for the variant.

In some aspects, the techniques described herein relate to a method, wherein the historic churn probability includes a calculation based on which of the plurality of quality of experience categories the historic quality of experience performance for each served media object in the churn period.

In some aspects, the techniques described herein relate to a method, wherein the historic churn probability is determined relative to a total number of media objects having been served in the churn period.

In some aspects, the techniques described herein relate to a method, wherein the churn cost value includes the change in churn probability combined with a churn cost associated with the requesting user leaving a service provider within the churn period.

In some aspects, the techniques described herein relate to a method, wherein serving the selected variant includes transmitting the selected variant over a forward link between a service provider and a requesting user.

In some aspects, the techniques described herein relate to a method, wherein the forward link includes a shared forward link.

In some aspects, the techniques described herein relate to a method, wherein the request is received over a bidirectional communication link including the forward link.

In some aspects, the techniques described herein relate to a method, wherein the bidirectional communication link includes a satellite link of a satellite communication network.

In some aspects, the techniques described herein relate to a method, wherein the request is received over a return communication link different than the forward link.

In some aspects, the techniques described herein relate to a method, wherein the forward link includes a satellite link of a satellite communication network, and the return communication link includes a different communication network.

In some aspects, the techniques described herein relate to a system for serving a media object to a user in a communications system, including: a provider content module executed on a computing device at a service provider, the provider content module operative to: receive a request for a media object from a user terminal of the communication system, and identify a plurality of variants available for the media object; a delivery utility calculation module operative to calculate a delivery utility for each of the plurality of variants; and a forward link between the service provider and the user terminal for serving a selected variant from the plurality of variants based on the delivery utility of the selected variant relative to others of the plurality of variants.

In some aspects, the techniques described herein relate to a system, wherein the delivery utility calculation module calculates the delivery utility for a variant at least based on one or more of: a network resource usage for delivery of the variant, and a predicted quality of experience the variant is expected to provide the user.

In some aspects, the techniques described herein relate to a system, wherein the delivery utility of the variant is based on the network resource usage and the predicted quality of experience.

In some aspects, the techniques described herein relate to a system, wherein the delivery utility calculation module determines a weighted network resource usage for the variant, the weighted network resource usage representing the network resource usage of a service provider for delivery of the variant to the user.

In some aspects, the techniques described herein relate to a system, wherein the weighted network resource usage includes a provisioning cost value.

In some aspects, the techniques described herein relate to a system, wherein the provisioning cost value is dependent is based upon a time of the request relative to a plurality of time periods.

In some aspects, the techniques described herein relate to a system, wherein the plurality of time periods at least includes a peak busy period and an off-peak period.

In some aspects, the techniques described herein relate to a system, wherein a provisioning cost rate for the peak busy period is greater than for the off-peak period.

In some aspects, the techniques described herein relate to a system, wherein the provisioning cost value is dependent on a size of the variant to be transmitted using a shared forward link.

In some aspects, the techniques described herein relate to a system, further including: determining a weighted probability of a quality of experience corresponding to the predicted quality of experience the variant is expected to provide the user.

In some aspects, the techniques described herein relate to a system, wherein the weighted probability of the quality of experience quantifies an effect of an adverse experience resulting from delivery of the variant.

In some aspects, the techniques described herein relate to a system, wherein the weighted probability of the quality of experience includes a churn cost value representative of an effect of the predicted quality of experience on the user.

In some aspects, the techniques described herein relate to a system, wherein the churn cost value is based on the predicted quality of experience for the requesting user having received the variant.

In some aspects, the techniques described herein relate to a system, wherein the predicted quality of experience includes a probability distribution of a quality of experience for serving the variant being categorized into each of a plurality of quality of experience categories.

In some aspects, the techniques described herein relate to a system, wherein each of the plurality of quality of experience categories is defined by one or more quality of experience performance indicators.

In some aspects, the techniques described herein relate to a system, wherein the one or more quality of experience performance indicators include one or more of: whether a media object start failure occurs, whether a media object playback failure occurs, whether a user exits before playback start after a threshold start time, whether a media object begins playback within a threshold playback time, or a minimum fidelity based on a user screen associated with the request.

In some aspects, the techniques described herein relate to a system, further including: a quality of experience probability module operative to apply a quality of experience probability model to determine the probability distribution of the variant being categorized into each of the plurality of quality of experience categories.

In some aspects, the techniques described herein relate to a system, wherein the quality of experience probability model is at least partially based on a source of the media object being one of a server side of the communications system or a local cache in local storage of the requesting user.

In some aspects, the techniques described herein relate to a system, wherein the quality of experience probability model is at least partially based on one or more of a bitrate of the variant, a screen size associated with the request, a genre of the media object, and current network conditions.

In some aspects, the techniques described herein relate to a system, wherein the delivery utility calculation module is further operative to: evaluate a change in churn probability by calculating a difference between a historic churn probability based on historic quality of experience performance over a churn period and a modified churn probability based on the historic quality of experience performance and the probability distribution of the quality of experience probability of the variant over the plurality of quality of experience categories.

In some aspects, the techniques described herein relate to a system, wherein the change in churn probability includes a weighted the change in churn probability for each of the plurality of quality of experience categories for the variant.

In some aspects, the techniques described herein relate to a system, wherein the historic churn probability includes a calculation based on which of the plurality of quality of experience categories the historic quality of experience performance for each served media object in the churn period.

In some aspects, the techniques described herein relate to a system, wherein the historic churn probability is determined relative to a total number of media objects having been served in the churn period.

In some aspects, the techniques described herein relate to a system, wherein the churn cost value includes the change in churn probability multiplied by a churn cost associated with the requesting user leaving the service provider within the churn period.

In some aspects, the techniques described herein relate to a system, wherein the provider content module receives the request over a bidirectional link including the forward link.

In some aspects, the techniques described herein relate to a system, wherein the bidirectional link includes a satellite link of a satellite communication network.

In some aspects, the techniques described herein relate to a system, wherein the provider content module receives the request over a return link different than the forward link.

In some aspects, the techniques described herein relate to a system, wherein the forward link includes a satellite link of a satellite communication network, and the return link includes a different communication network in operative communication with the provider content module.

In some aspects, the techniques described herein relate to a system, wherein the forward link includes a shared forward link.

While this specification contains many specific implementation details, these should not be construed as limitations on the scope of any technologies or of what may be claimed, but rather as descriptions of features specific to particular implementations of the particular described technology. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

A number of implementations of the described technology have been described. Nevertheless, it will be understood that various modifications can be made without departing from the spirit and scope of the recited claims.

What is claimed is:

1. A method for serving a media object to a user in a communications system, comprising:
receiving a request for the media object;
identifying a plurality of variants available for the media object;
calculating a delivery utility for each of the plurality of variants;
selecting a selected variant from the plurality of variants based on the delivery utility of the selected variant relative to others of the plurality of variants; and
serving the selected variant to the user to satisfy the request.

2. The method of claim 1, wherein the delivery utility for a variant is calculated at least based on one or more of:
a network resource usage for delivery of the variant, and
a predicted quality of experience the variant is expected to provide the user.

3. The method of claim 2, wherein the delivery utility of the variant is based on the network resource usage and the predicted quality of experience.

4. The method of claim 2, further comprising:
determining a weighted network resource usage for the variant, the weighted network resource usage representing the network resource usage of a service provider for delivery of the variant to the user.

5. The method of claim 4, wherein the weighted network resource usage comprises a provisioning cost value.

6. The method of claim 5, wherein the provisioning cost value is dependent is based upon a time of the request relative to a plurality of time periods.

7. The method of claim 6, wherein the plurality of time periods at least includes a peak period and an off-peak period.

8. The method of claim 7, wherein a provisioning cost rate for the peak period is greater than for the off-peak period.

9. The method of claim 5, wherein the provisioning cost value is dependent on a size of the variant to be transmitted using a shared forward link.

10. The method of claim 2, further comprising:
determining a weighted probability of a quality of experience corresponding to the predicted quality of experience the variant is expected to provide the user.

11. The method of claim 10, wherein the weighted probability of the quality of experience quantifies an effect of an adverse experience resulting from delivery of the variant.

12. The method of claim 11, wherein the weighted probability of the quality of experience comprises a churn cost value representative of an effect of the predicted quality of experience on the user.

13. The method of claim 12, wherein the churn cost value is based on a predicted change in a probability the user discontinues service with a service provider within a churn period in response to serving the variant to a requesting user.

14. The method of claim 12, wherein the churn cost value is based on the predicted quality of experience for a requesting user having received the variant.

15. The method of claim 14, wherein the predicted quality of experience comprises a probability distribution of a quality of experience for serving the variant being categorized into each of a plurality of quality of experience categories.

16. The method of claim 15, wherein each of the plurality of quality of experience categories is defined by one or more quality of experience performance indicators.

17. The method of claim 16, wherein the one or more quality of experience performance indicators comprise one or more of:
whether a media object start failure occurs,
whether a media object playback failure occurs,
whether a user exits before playback start after a threshold start time,
whether a media object begins playback within a threshold playback time, or a minimum fidelity based on a user screen associated with the request.

18. The method of claim 16, further comprising:
determining the probability distribution of the variant being categorized into each of the plurality of quality of experience categories based on a quality of experience probability model.

19. The method of claim 18, wherein the quality of experience probability model is at least partially based on a source of the media object being one of a server side of the communications system or a local cache in local storage of the requesting user.

20. The method of claim 18, wherein the quality of experience probability model is at least partially based on one or more of a bitrate of the variant, a screen size associated with the request, a genre of the media object, and current network conditions.

21. The method of claim 15, further comprising:
evaluating a change in churn probability by calculating a difference between a historic churn probability based on historic quality of experience performance over a churn period and a modified churn probability based on the historic quality of experience performance and the probability distribution of the quality of experience probability of the variant over the plurality of quality of experience categories.

22. The method of claim 21, wherein the change in churn probability comprises a weighted calculation of the change in churn probability for each of the plurality of quality of experience categories for the variant.

23. The method of claim 21, wherein the historic churn probability comprises a calculation based on which of the plurality of quality of experience categories the historic quality of experience performance for each served media object in the churn period.

24. The method of claim 23, wherein the historic churn probability is determined relative to a total number of media objects having been served in the churn period.

25. The method of claim 21, wherein the churn cost value comprises the change in churn probability combined with a churn cost associated with the requesting user leaving a service provider within the churn period.

26. The method of claim 1, wherein serving the selected variant comprises transmitting the selected variant over a forward link between a service provider and a requesting user.

27. The method of claim 26, wherein the forward link comprises a shared forward link.

28. The method of claim 26, wherein the request is received over a bidirectional communication link comprising the forward link.

29. The method of claim 28, wherein the bidirectional communication link comprises a satellite link of a satellite communication network.

30. The method of claim 26, wherein the request is received over a return communication link different than the forward link.

31. The method of claim 30, wherein the forward link comprises a satellite link of a satellite communication network, and the return communication link comprises a different communication network.

32. A system for serving a media object to a user in a communications system, comprising:
a provider content module executed on a computing device at a service provider, the provider content module operative to:
receive a request for a media object from a user terminal of the communication system, and
identify a plurality of variants available for the media object;
a delivery utility calculation module operative to calculate a delivery utility for each of the plurality of variants; and
a forward link between the service provider and the user terminal for serving a selected variant from the plurality of variants based on the delivery utility of the selected variant relative to others of the plurality of variants.

33. The system of claim 32, wherein the delivery utility calculation module calculates the delivery utility for a variant at least based on one or more of:
a network resource usage for delivery of the variant, and
a predicted quality of experience the variant is expected to provide the user.

34. The system of claim 33, wherein the delivery utility of the variant is based on the network resource usage and the predicted quality of experience.

35. The system of claim 33, wherein the delivery utility calculation module determines a weighted network resource usage for the variant, the weighted network resource usage representing the network resource usage of a service provider for delivery of the variant to the user.

36. The system of claim 35, wherein the weighted network resource usage comprises a provisioning cost value.

37. The system of claim 36, wherein the provisioning cost value is dependent is based upon a time of the request relative to a plurality of time periods.

38. The system of claim 37, wherein the plurality of time periods at least includes a peak busy period and an off-peak period.

39. The system of claim 38, wherein a provisioning cost rate for the peak busy period is greater than for the off-peak period.

40. The system of claim 36, wherein the provisioning cost value is dependent on a size of the variant to be transmitted using a shared forward link.

41. The system of claim 33, further comprising:
determining a weighted probability of a quality of experience corresponding to the predicted quality of experience the variant is expected to provide the user.

42. The system of claim 41, wherein the weighted probability of the quality of experience quantifies an effect of an adverse experience resulting from delivery of the variant.

43. The system of claim 41, wherein the weighted probability of the quality of experience comprises a churn cost value representative of an effect of the predicted quality of experience on the user.

44. The system of claim 43, wherein the churn cost value is based on the predicted quality of experience for the requesting user having received the variant.

45. The system of claim 44, wherein the predicted quality of experience comprises a probability distribution of a quality of experience for serving the variant being categorized into each of a plurality of quality of experience categories.

46. The system of claim 45, wherein each of the plurality of quality of experience categories is defined by one or more quality of experience performance indicators.

47. The system of claim 46, wherein the one or more quality of experience performance indicators comprise one or more of:
whether a media object start failure occurs,
whether a media object playback failure occurs,
whether a user exits before playback start after a threshold start time,
whether a media object begins playback within a threshold playback time, or a minimum fidelity based on a user screen associated with the request.

48. The system of claim 46, further comprising:
a quality of experience probability module operative to apply a quality of experience probability model to determine the probability distribution of the variant being categorized into each of the plurality of quality of experience categories.

49. The system of claim 48, wherein the quality of experience probability model is at least partially based on a source of the media object being one of a server side of the communications system or a local cache in local storage of the requesting user.

50. The system of claim 48, wherein the quality of experience probability model is at least partially based on one or more of a bitrate of the variant, a screen size associated with the request, a genre of the media object, and current network conditions.

51. The system of claim 45, wherein the delivery utility calculation module is further operative to:
evaluate a change in churn probability by calculating a difference between a historic churn probability based on historic quality of experience performance over a churn period and a modified churn probability based on the historic quality of experience performance and the probability distribution of the quality of experience probability of the variant over the plurality of quality of experience categories.

52. The system of claim 51, wherein the change in churn probability comprises a weighted the change in churn probability for each of the plurality of quality of experience categories for the variant.

53. The system of claim 51, wherein the historic churn probability comprises a calculation based on which of the plurality of quality of experience categories the historic quality of experience performance for each served media object in the churn period.

54. The system of claim 53, wherein the historic churn probability is determined relative to a total number of media objects having been served in the churn period.

55. The system of claim 51, wherein the churn cost value comprises the change in churn probability multiplied by a churn cost associated with the requesting user leaving the service provider within the churn period.

56. The system of claim 32, wherein the provider content module receives the request over a bidirectional link comprising the forward link.

57. The system of claim 56, wherein the bidirectional link comprises a satellite link of a satellite communication network.

58. The system of claim 32, wherein the provider content module receives the request over a return link different than the forward link.

59. The system of claim 58, wherein the forward link comprises a satellite link of a satellite communication network, and the return link comprises a different communication network in operative communication with the provider content module.

60. The system of claim 32, wherein the forward link comprises a shared forward link.
